(19) United States
(12) Patent Application Publication
(10) Pub. No.: US 2013/0038839 A1
(43) Pub. Date: Feb. 14, 2013

(54) OPTICAL DEVICE, METHOD FOR PRODUCING OPTICAL DEVICE, AND PROJECTION-TYPE IMAGING APPARATUS

(71) Applicants: Takehiko UEHARA, Minowa-machi (JP); Akiko KAWASE, Matsumoto-shi (JP); Mitsuru MIYABARA, Matsumoto-shi (JP)

(72) Inventors: Takehiko UEHARA, Minowa-machi (JP); Akiko KAWASE, Matsumoto-shi (JP); Mitsuru MIYABARA, Matsumoto-shi (JP)

(73) Assignee: SEIKO EPSON CORPORATION, Tokyo (JP)

(21) Appl. No.: 13/564,262

(22) Filed: Aug. 1, 2012

(30) Foreign Application Priority Data
Aug. 10, 2011 (JP) 2011-174925

(51) Int. Cl. G03B 21/14; B32B 37/12; B32B 3/02

(52) U.S. Cl. 353/20; 428/76; 156/305

(57) ABSTRACT

An optical device includes: a light transmissive first substrate; a light transmissive second substrate; a polarizing layer as a resin layer disposed therebetween; a first bonding film which is an adhesive and bonds the polarizing layer to the first substrate; and a second bonding film which is formed of a plasma-polymerized film and bonds the polarizing layer to the second substrate, wherein the outer shapes of the first substrate and the second substrate are larger than that of the polarizing layer, and a sealing part for sealing with a sealant is provided on a lateral surface of the polarizing layer such that the sealing part is interposed between the first substrate and the second substrate.

### BACKGROUND

1. Technical Field

The present invention relates to a polarizing plate, other optical devices, a method for producing such an optical device, and a projection-type imaging apparatus using such an optical device.

2. Related Art

A projection-type imaging apparatus such as a liquid crystal projector is configured such that light from a light source is modulated by a light modulator according to image information to be projected and the light modulated by the light modulator is projected by a projection optical device. A polarizing plate is disposed between the light modulator and the light source.

In the related art, as the polarizing plate, there has been disclosed a polarizing plate obtained by bonding a polarizing film to glass (JP-A-10-039138). In JP-A-10-039138, as the polarizing film, for example, a polarizing film including iodine or a dichroic dye as a polarizer and a transparent polyvinyl alcohol (PVA) film as a substrate is disclosed, and the polarizing film has a thickness of 10 to 50 μm, preferably about 25 to 35 μm. As the polarizing film, a so-called H film formed by stretching a PVA thin film while heating, and then immersing the film in a solution called an H ink containing a large amount of iodine (potassium iodide) to allow the film to absorb iodine, a film formed by allowing a polyvinyl butyral film to absorb iodine, a film formed by allowing a uniaxially stretched PVA film to absorb a dichroic dye, or the like is used.

Further, there has been disclosed a polarizing plate in which a bonding agent layer is formed on each of inner surfaces facing each other of transparent substrates facing and spaced apart from each other, and a polarizer formed of PVA or the like is provided on one of these bonding agent layers, and a retardation film is provided on the other bonding agent layer, and the polarizer and the retardation film are bonded to each other through a bonding agent layer, and exposed portions of the polarizer and the retardation film, which are not in contact with the bonding agent layers, are sealed with a sealant (JP-A-2010-117537).

Further, there has been proposed a method for producing a polarizing plate in which a transparent substrate is directly bonded to both surfaces of a polarizer with a bonding agent, wherein in order to prevent the occurrence of outer shape abnormality such as wrinkles, a transparent substrate is bonded to one surface of a polarizer formed of PVA or the like with a bonding agent, followed by heating under pressure, and then, a transparent substrate is bonded to the other surface of the polarizer with a bonding agent (JP-A-2010-191203).

Recently, in a liquid crystal projector, the output of a white light source lamp is increased and an arc length is decreased, and therefore, a thermal load to each optical device mounted in an optical engine is being increased. An optical device in the related art cannot withstand light of a high luminance lamp and is deteriorated, resulting in decreasing the optical properties such as transmittance. Alternatively, a problem arises that an optical device, a bonding agent, or the like, which is formed of a resin, is deformed by heat.

That is, a polarizer formed of, as a raw material, an organic film disclosed in JP-A-10-039138, JP-A-2010-117537, or JP-A-2010-191203 has a problem that a defect such as yellow discoloration due to light resulting from increasing the output or decreasing the arc length or heat generated by the light is caused.

Therefore, in the related art, there has been proposed a bonded article which includes: a first adherend having a first substrate and a first bonding film which is formed on the first substrate by a plasma polymerization method, contains a Si skeleton containing a siloxane (Si—O) bond and having a crystallinity of 45% or less and also contains a leaving group which is composed of an organic group and binds to this Si skeleton; and a second adherend having a second substrate and a second bonding film which is formed on the second substrate by a plasma polymerization method, and has the same structure as the first bonding film, wherein the first adherend and the second adherend are bonded to each other by a bonding property exhibited in each of a region on a surface of the first bonding film and a region on a surface of the second bonding film by applying energy to each of a region of at least a part of the first bonding film and a region of at least a part of the second bonding film so as to release at least the leaving group present in the vicinity of the surface of the first bonding film and the second bonding film from the Si skeleton (Japanese Patent No. 4337935).

Further, in the related art, there has been proposed a polarizing plate formed by bonding a glass substrate to a polarizing film using the bonding film proposed in Japanese Patent No. 4337935 (JP-A-2009-098465). The polarizing plate proposed in JP-A-2009-098465 includes a light transmissive substrate, a polarizing layer, and a bonding film which bonds the substrate to the polarizing layer, and has a configuration such that the bonding film contains a Si skeleton which has an atomic structure containing a siloxane (Si—O) bond and a leaving group which binds to the Si skeleton, and the bonding film bonds the substrate to the polarizing layer by a bonding property exhibited in a region on a surface of the bonding film by applying energy to a region of at least a part of the bonding film so as to release the leaving group present in the vicinity of the surface of the bonding film from the Si skeleton.

Similarly, there has been proposed a laminated wavelength plate formed by bonding two quartz crystal substrates to each other using the bonding film described in Japanese Patent No. 4337935 (JP-A-2009-258404).

Therefore, the present inventors tried to realize a polarizing plate having extremely high light resistance using the bonding film proposed in Japanese Patent No. 4337935, JP-A-2009-098465, or JP-A-2009-258404 while using an organic film as a material of a polarizing device.

However, it was found that when a plasma-polymerized film is used as the bonding film, the thickness of the bonding film is several tens nanometers, for example, in the case of Japanese Patent No. 4337935, an extremely thin film having a thickness of 1 to 10000 nm, preferably 2 to 800 nm is used, and therefore, if both principal surfaces of a film polarizer are sandwiched by inorganic light transmissive substrates, the irregularities of the surface of the film polarizer cannot be completely absorbed because the bonding film is thin, and therefore, an air bubble or the like is incorporated to cause an external appearance defect, resulting in causing an adverse effect on the optical properties such as transmissibility. For example, PVA has a hygroscopic property and swells or shrinks depending on the humidity, and therefore, the film polarizer and the light transmissive substrates may be detached from each other.

Further, since the bonding film is formed on both principal surfaces of the film polarizer by a plasma polymerization method, the time of exposure of the film polarizer to heat generated by a plasma is long, and therefore, a problem arises that the film polarizer itself is deteriorated or deformed.

In addition, in the case where a light transmissive glass substrate and a synthetic resin polarizer are bonded to each other using a plasma-polymerized film, the bonding strength is lower than in the case where glass substrates are bonded to each other. Further, since a light transmissive quartz crystal substrate and a synthetic resin polarizer have different linear expansion coefficients, the both members are easily detached from each other from an end portion. In the case where a minute air bubble, dust, or the like is incorporated in the plasma-polymerized film, the light transmissive substrate may sometimes rise up. In the case where an antireflection film composed of a material such as MgF₂ is formed on a surface of a light transmissive substrate, a tensile stress is generated on this antireflection film so that the light transmissive substrate curves from both ends to the center into a U shape and may be detached from the synthetic resin polarizer. In particular, when an outside edge surface of a bonding portion is exposed to the outside, the light transmissive substrate is easily detached from the polarizer or the like.

### SUMMARY

An advantage of some aspects of the invention is to provide an optical device, which has extremely high light resistance and excellent optical properties such as transmissibility, and in which a polarizer and a substrate are hardly detached from each other, a method for producing such an optical device, and a projection-type imaging apparatus using such an optical device.

### Application Example 1

This application example of the invention is directed to an optical device including: a light transmissive first substrate; a light transmissive second substrate; a resin layer; a first bonding film which bonds the first substrate to one principal surface of the resin layer; and a second bonding film which bonds the second substrate to the other principal surface of the resin layer, wherein the outer shapes of the first substrate and the second substrate are larger than that of the resin layer; a sealing part for sealing with a sealant is provided on a lateral surface of the resin layer such that the sealing part is interposed between the first substrate and the second substrate; the first bonding film is an adhesive, and the second bonding film contains a Si skeleton which has an atomic structure containing a siloxane (Si—O) bond and a leaving group which binds to the Si skeleton.

In this application example having this configuration, the first bonding film which bonds the first substrate to one principal surface of the resin layer is formed of an adhesive layer, for example, an acrylic adhesive layer, and therefore, a necessary strength can be ensured, and also the irregularities of the resin layer can be absorbed so as to prevent the incorporation of air bubbles, whereby the optical properties can be enhanced. Further, since the time of exposure of the resin layer to heat generated by a plasma can be decreased, the deterioration or deformation of the resin layer itself can be prevented. In addition, the adhesive itself has superior light resistance and heat resistance to a bonding agent.

Moreover, since the second bonding film which bonds the second substrate to the other principal surface of the resin layer is configured to contain a Si skeleton and a leaving group, the heat resistance is improved, and a defect such as yellow discoloration of the optical device due to light resulting from increasing the output or decreasing the arc length or heat generated by the light can be avoided.

Accordingly, an optical device having a long life and excellent optical properties can be provided.

Further, since the sealing part for sealing with a sealant is provided on a lateral surface of the resin layer such that the sealing part is interposed between the first substrate and the second substrate, i.e., a configuration in which the sealing part is sandwiched by an end portion of the first substrate and an end portion of the second substrate is adopted, the detachment of the end portion of the first substrate or the end portion of the second substrate from the resin layer or the like, which is caused due to the bonding of the second substrate to the resin layer through the second bonding film formed of a plasma-polymerized film or other reasons is prevented by the sealing part.

### Application Example 2

This application example of the invention is directed to the optical device described above, wherein the sealant is a cure-shrinkable bonding agent.

According to this application example having this configuration, by using a curable bonding agent such as a UV curable bonding agent or a thermosetting bonding agent as the sealant, the bonding agent shrinks after a recess is sealed with the bonding agent. Accordingly, since a force acts in such a direction that the end portion of the first substrate and the end portion of the second substrate come close to each other, the detachment of the first substrate or the second substrate from the resin layer can be more effectively prevented. For example, in the case where an antireflection film having a tensile stress is provided on a surface of the first substrate or the second substrate on the opposite side of the bonding film, this application example is particularly effective. Further, since the resin layer is compressed due to the shrinkage of the bonding agent, the irregularities of the resin layer can be absorbed, and therefore, the optical properties can be enhanced by preventing the incorporation of air bubbles.

### Application Example 3

This application example of the invention is directed to the optical device described above, wherein the outer shape of one of the first substrate and the second substrate is larger than that of the other one.

According to this application example having this configuration, a portion which is an end portion of one of the first substrate and the second substrate and protrudes from the other one becomes a mounting portion in the apparatus, and therefore, the mounting operation of the optical device becomes easy.

### Application Example 4

This application example of the invention is directed to the optical device described above, wherein the sealant is attached to a lateral surface of the other one of the first substrate and the second substrate.

According to this application example having this configuration, since the sealing part is provided not only on the lateral surface of the resin layer, but also on the lateral surface of the other one of the first substrate and the second substrate, a larger sealing effect can be obtained.

### Application Example 5

This application example of the invention is directed to the optical device described above, wherein the resin layer is a polarizing layer or a retardation element.

According to this application example having this configuration, an optical article having a polarizing plate or a retardation plate capable of exhibiting the above-described effect can be provided.

### Application Example 6

This application example of the invention is directed to a method for producing an optical device, which is a method for producing the optical device having the above-described configuration, including: bonding the first substrate to one principal surface of the resin layer with an adhesive; forming a first bonding layer, which contains a Si skeleton that has an atomic structure containing a siloxane (Si—O) bond and a leaving group that binds to the Si skeleton, on at least one principal surface of the other principal surface of the resin layer and a principal surface of the second substrate; activating the first bonding layer formed in the forming of the first bonding layer; bonding the resin layer to the second substrate so as to integrate the members; and supplying a sealant to a region on a lateral surface of the resin layer, the region being interposed between the first substrate and the second substrate.

According to this application example having this configuration, the above-described effect can be obtained.

### Application Example 7

This application example of the invention is directed to the method for producing an optical device described above, wherein in the supplying of the sealant, the sealant is supplied to the region through a notch formed in one of an end portion of the first substrate and an end portion of the second substrate.

According to this application example having this configuration, since the sealant can be supplied to the region through the notch from an upper side of one of the first substrate and the second substrate having the notch formed therein, the supplying of the sealant can be easily performed, and an optical device having the above-described effect can be efficiently produced. In addition, by forming the notch in one of the first substrate and the second substrate, the front and rear surfaces of the optical device can be easily distinguished from each other.

### Application Example 8

This application example of the invention is directed to a projection-type imaging apparatus including: a light source; a light modulator which modulates light from the light source according to image information; a projection optical device which projects the light modulated by the light modulator; and a polarizing plate, wherein the polarizing plate is disposed on at least one of a light incident side and alight exit side of the light modulator, and the polarizing plate is the optical device having the above-described configuration.

According to this application example having this configuration, a projection-type imaging apparatus capable of exhibiting the above-described effect can be provided.

### BRIEF DESCRIPTION OF THE DRAWINGS

The invention will be described with reference to the accompanying drawings, wherein like numbers reference like elements.

FIG. 1 is a cross-sectional view showing an optical device according to a first embodiment of the invention.

FIG. 2 is a schematic structural view of a plasma polymerization apparatus.

FIGS. 3A to 3D are views illustrating a state where a plasma-polymerized film is formed on a polarizing layer.

FIG. 4A is a schematic view illustrating a molecular structure before energy is applied to the plasma-polymerized film, and FIG. 4B is a schematic view illustrating a molecular structure after energy is applied to the plasma-polymerized film.

FIGS. 5A to 5D are views illustrating a bonding step.

FIG. 6 is a cross-sectional view showing an optical device according to a second embodiment of the invention.

FIGS. 7A to 7E are schematic views showing a procedure for producing the optical device according to the second embodiment.

FIG. 8 is a cross-sectional view showing an optical device according to a third embodiment of the invention.

FIGS. 9A to 9D are schematic views showing a procedure for producing the optical device according to the third embodiment.

FIG. 10 is a cross-sectional view showing an optical device according to a fourth embodiment of the invention.

FIG. 11 is a cross-sectional view showing an optical device according to a fifth embodiment of the invention.

FIG. 12 is a perspective view showing a process for producing an optical device according to a sixth embodiment of the invention.

FIG. 13 is a cross-sectional view showing an optical device according to a seventh embodiment of the invention.

FIG. 14 is a schematic view showing a projection-type imaging apparatus according to an eighth embodiment of the invention.

FIGS. 15A to 15D are schematic views showing a procedure for producing an optical device according to a ninth embodiment of the invention.

FIGS. 16A and 16B are graphs showing the results of Example for the evaluation of reliability.

FIGS. 17A and 17B are graphs showing the results of Example for the evaluation of reliability.

FIGS. 18A and 18B are graphs showing the results of Comparative Example for the evaluation of reliability.

FIGS. 19A and 19B are graphs showing the results of Comparative Example for the evaluation of reliability.

### DESCRIPTION OF EXEMPLARY EMBODIMENTS

Hereinafter, embodiments of the invention will be described with reference to the accompanying drawings. Note that in the description of the respective embodiments, the same reference numerals and symbols are attached to the same constituent elements, and the description thereof is omitted or simplified.

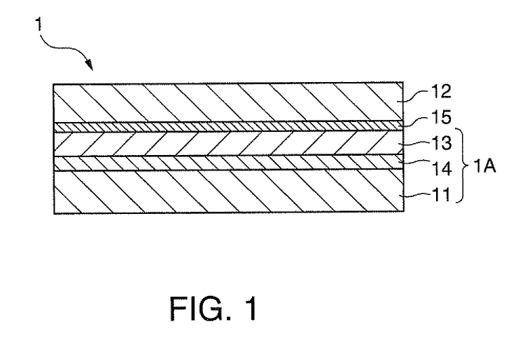

A first embodiment will be described with reference to FIGS. 1 to 5D.

In FIG. 1, a cross section of an optical device according to the first embodiment is shown.

In FIG. 1, an optical device 1 according to the first embodiment is a polarizing plate provided with: a light transmissive first substrate 11; a light transmissive second substrate 12; a polarizing layer 13 as a resin layer; a first bonding film 14 which bonds the first substrate 11 to one principal surface of the polarizing layer 13; and a second bonding film 15 which bonds the second substrate 12 to the other principal surface of the polarizing layer 13. The optical device 1 according to the first embodiment is used in a projection-type imaging apparatus such as a liquid crystal projector, or other electronic apparatuses.

Each of the first substrate 11 and the second substrate 12 has a thickness of 700 μm±100 μm (600 μm or more and 800 μm or less), and is a plate material having a rectangular planar shape.

As a material of the first substrate 11 and the second substrate 12, for example, a light transmissive inorganic material is used. Specific examples thereof include a silicate glass, a borosilicate glass, a titanium silicate glass, a fluoride glass such as a zirconium fluoride glass, fused quartz, quartz crystal, sapphire, a YAG crystal, fluorite, magnesia, and spinel (MgO.Al₂O₃). By forming the light transmissive first substrate 11 and the light transmissive second substrate 12 of an inorganic material, the planarity is improved, and the retention of a given shape can be improved. Further, among these materials, a material having a thermal conductivity of 5 W/mK or more is preferred from the viewpoint of efficiently radiating heat generated in the polarizing layer 13 to the outside to decrease the temperature of the polarizing layer 13. Examples of such a material include sapphire (thermal conductivity: 40 W/mK) and quartz crystal (thermal conductivity: 8 W/mK).

The outer surfaces of the first substrate 11 and the second substrate 12 which are in contact with the air are subjected to an antireflection treatment according to the wavelength of light to be used. Examples of the antireflection treatment include a method of forming a dielectric multilayer film by a sputtering process or a vacuum vapor deposition process, and a method of providing one or more low-refractive index layers by coating. Further, the antireflection surfaces may be subjected to an antifouling treatment for preventing dirt from adhering to the surfaces. Examples of the antifouling treatment include the formation of a thin film layer containing fluorine to such an extent that it hardly affects the antireflection performance on the surface.

The polarizing layer 13 is a polarizer formed of a synthetic resin selected from a polyvinyl alcohol (PVA), a polycarbonate, and a polyolefin, and has a thickness of 25 μm±10 μm (15 μm or more and 35 μm or less), and is a film-shaped member having the same planar shape as that of the first substrate 11 and the second substrate 12.

As the polarizing layer 13, there are a polarizing layer of a type called K-type polarizer, K-sheet, or KE-film, and a polarizing layer of a type called H-type polarizer.

The polarizing layer of a type called K-type polarizer is a polarizer produced by, for example, dehydrating a PVA-based resin to form a double bond in a main chain. In order to produce a K-type polarizer, for example, the following method can be used. A polymer sheet containing a hydroxylated linear polymer such as PVA is uniaxially stretched, the hydroxylated linear polymer of this polymer sheet is oriented along the stretching direction, the resulting oriented sheet is bonded to a support, the supported oriented sheet is treated under a condition sufficient to effect catalytic dehydration of the oriented sheet, whereby a light-absorbing vinylene block segment is formed in the polymer.

The polarizing layer of a type called H-type polarizer is a polarizer produced by, for example, using dichroic iodine, a dichroic dye, or the like for a PVA-based resin subjected to a stretching treatment, and PVA chains are crosslinked using boric acid.

The first bonding film 14 is an adhesive layer formed of an acrylic-based or silicone-based adhesive and has a thickness of 15 μm±5 μm (10 μm or more and 20 μm or less).

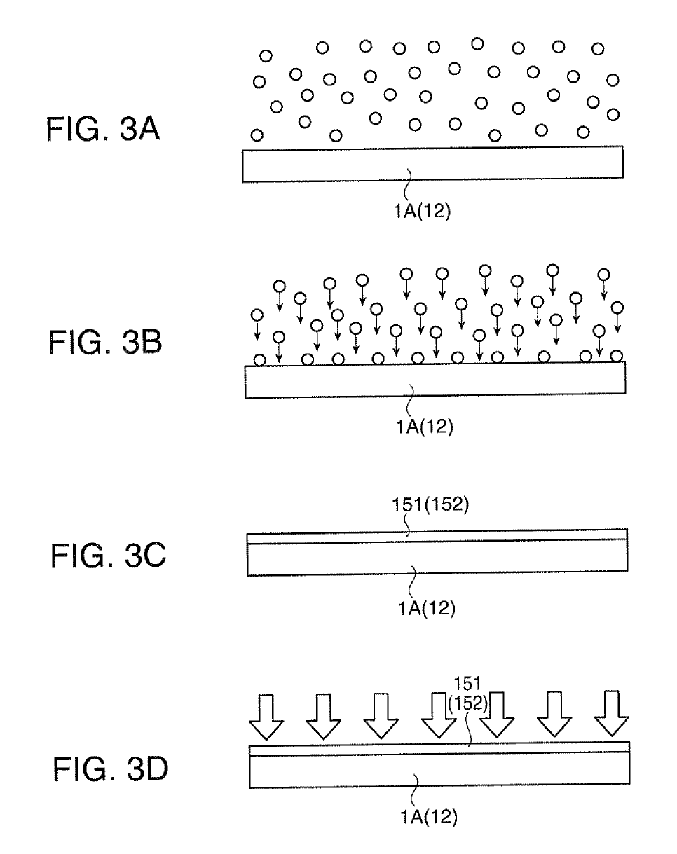

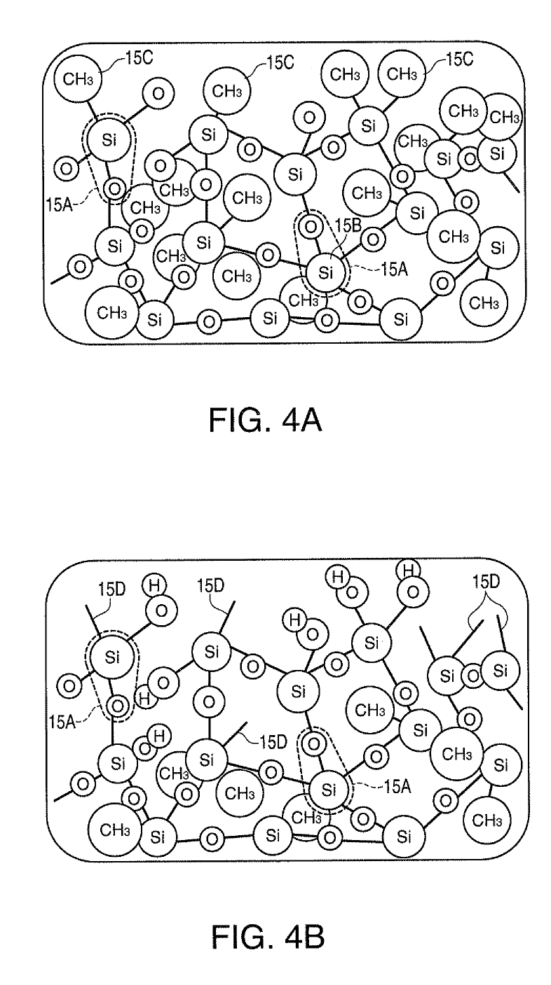

The second bonding film 15 is formed of a plasma-polymerized film (see FIGS. 3A to 4B) which has: a first adherend having a first bonding layer 151 formed on the polarizing layer 13 by a plasma polymerization method, containing a Si skeleton 15B which contains a siloxane (Si—O) bond and has a crystallinity of 45% or less, and also containing a leaving group 15C which is composed of an organic group and binds to the Si skeleton 15B; and a second adherend having a second bonding layer 152 formed on the second substrate 12 by a plasma polymerization method and formed of the same material as the first bonding layer 151. The second bonding film 15 has a thickness of 300 nm or more and 700 nm or less. If the thickness of the second bonding film 15 is set to less than 300 nm, the irregularities of the polarizing layer 13 cannot be absorbed and fine air bubbles remain in a streaky form, and if the thickness of the second bonding film 15 is set to more than 700 nm, due to the heat during the film formation, the polarizing layer 13 is shrunk and deformed from an outer peripheral portion thereof.

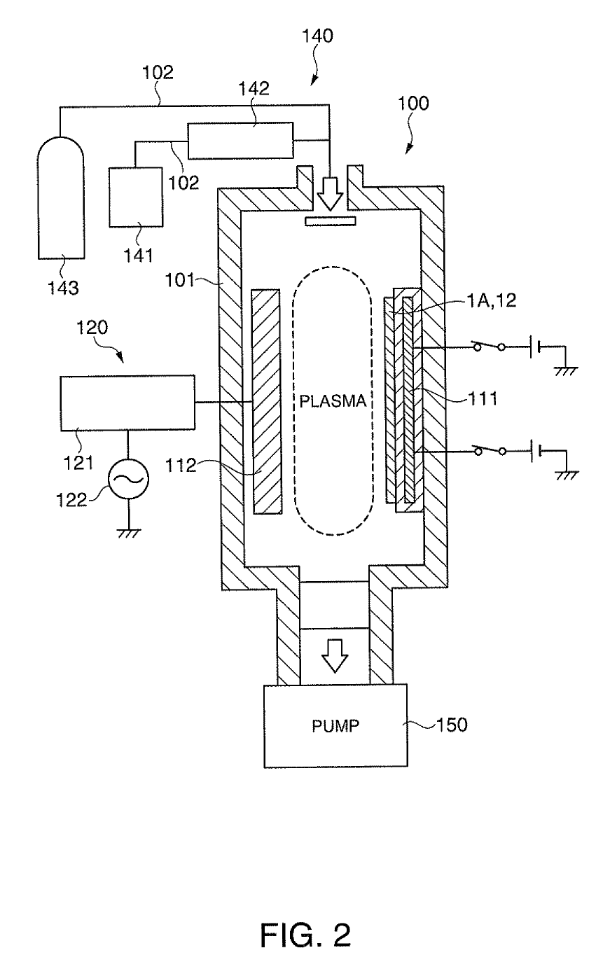

Next, the method for producing the optical device 1 according to the first embodiment will be described with reference to FIGS. 2 to 5D.

### 1. Adhesion Step

The first substrate 11 and the polarizing layer 13 are bonded to each other with an adhesive.

Therefore, an adhesive is applied to both or one of the first substrate 11 and the polarizing layer 13, and the first substrate 11 and the polarizing layer 13 are bonded to each other. Unlike the case of using a bonding agent, a UV curing step is not needed when the first substrate 11 and the polarizing layer 13 are bonded to each other.

In a state where the first substrate 11 and the polarizing layer 13 are bonded to each other, a polarizing plate unit 1A in which the first bonding film 14 is formed between the first substrate 11 and the polarizing layer 13 is formed.

### 2. Plasma-Polymerized Film Formation Step

Next, a step of forming a plasma-polymerized film will be described.

First, an apparatus for forming a plasma-polymerized film will be described.

FIG. 2 is a schematic structural view of a plasma polymerization apparatus.

In FIG. 2, a plasma polymerization apparatus 100 is provided with a chamber 101, a first electrode 111 and a second electrode 112, each of which is provided in the chamber 101, a power supply circuit 120 which applies a high-frequency voltage between the first electrode 111 and the second electrode 112, a gas supply section 140 which supplies a gas into the chamber 101, and an exhaust pump 150 which exhausts the gas inside the chamber 101.

The power supply circuit 120 has a matching box 121 and a high-frequency power supply 122. The gas supply section 140 has a liquid storage section 141 which stores a liquid film material (a raw material liquid), a vaporizer 142 which vaporizes the liquid film material to form a raw material gas, a gas cylinder 143 which stores a carrier gas, and a pipe 102 which connects these members. The carrier gas stored in the gas cylinder 143 is a gas to be introduced into the chamber 101 for maintaining electric discharge caused by an electric field, and examples thereof include argon gas and helium gas.

The film material stored in the liquid storage section 141 is a raw material for forming a plasma-polymerized film on the first substrate 11 or the second substrate 12 by the plasma polymerization apparatus 100. Examples of the raw material gas include organosiloxanes such as methylsiloxane, hexamethyldisiloxane, octamethyltrisiloxane, decamethyltetrasiloxane, decamethylcyclopentasiloxane, octamethylcyclotetrasiloxane, and methylphenylsiloxane. A polyorganosiloxane generally has water repellency, however, an organic group thereof can be easily released through any of various activation treatments, and therefore, a polyorganosiloxane can be easily converted into a hydrophilic compound.

### 2-1. Bonding Layer Formation Step

Subsequently, a first bonding layer formation step of forming a first bonding layer by a plasma polymerization method on a plane surface of the polarizing layer 13 of the polarizing plate unit 1A, and a second bonding layer formation step of forming a second bonding layer by a plasma polymerization method on a plane surface of the second substrate 12 are performed.

FIGS. 3A to 3D are views illustrating a state where a plasma-polymerized film is formed on the polarizing layer, FIG. 4A is a schematic view illustrating a molecular structure before energy is applied to the plasma-polymerized film, and FIG. 4B is a schematic view illustrating a molecular structure after energy is applied to the plasma-polymerized film.

As shown in FIGS. 3A to 3C, the first bonding layer 151 is formed on the polarizing layer 13 of the polarizing plate unit 1A, and the second bonding layer 152 is formed on a plane surface of the second substrate 12. In this step, a predetermined amount of oxygen is introduced into the chamber 101 while allowing the first electrode 111 of the plasma polymerization apparatus 100 to hold the polarizing plate unit 1A or the second substrate 12, and also a high-frequency voltage is applied between the first electrode 111 and the second electrode 112 from the power supply circuit 120, whereby the optical member itself is activated (substrate activation).

Thereafter, the gas supply section 140 is activated, and a mixed gas of the raw material gas and the carrier gas is supplied into the chamber 101. The chamber 101 is filled with the supplied mixed gas, and the polarizing layer 13 of the polarizing plate unit 1A or the second substrate 12 is exposed to the mixed gas.

By applying a high-frequency voltage between the first electrode 111 and the second electrode 112, the molecules of the gas present between these electrodes 111 and 112 are ionized, whereby a plasma is generated. By the energy of the plasma, the molecules of the raw material gas are polymerized, and as shown in FIG. 3B, the resulting polymerized product is attached and deposited onto the surface of the polarizing plate unit 1A or the second substrate 12. As a result, as shown in FIG. 3C, the first bonding layer 151 is formed on the polarizing plate unit 1A, or the second bonding layer 152 is formed on the second substrate 12. The first bonding layer 151 and the second bonding layer 152 are each a plasma-polymerized film.

Here, the film formation temperature (the temperature of the substrate on which a film is formed) is 65° C. or higher and 85° C. or lower.

If the film formation temperature is lower than 65° C., the polarizing layer 13 in the form of a film is not softened, and minute irregularities cannot be compressed or deformed, and therefore, fine air bubbles remain in a streaky form. If the film formation temperature exceeds 85° C., the polarizing layer 13 in the form of a film is shrunk and deformed from an outer peripheral portion thereof due to the heat during film formation, and therefore, bonding failure is caused in the outer peripheral portion thereof. That is, if the temperature of the substrate is within the range of 65° C. to 85° C., an effect of the irregularities of the polarizing layer 13 in the form of a film can be eliminated and also bonding failure caused by thermal shrinkage deformation can be avoided.

### 2-2. Surface Activation Step

The plasma-polymerized film formed in the bonding layer formation step is activated.

As shown in FIG. 3D, energy is applied to the first bonding layer 151 and the second bonding layer 152, thereby activating the surfaces thereof. In this step, for example, a method of irradiation with a plasma, a method of contacting with ozone gas, a method of treatment with ozone water, a method of treatment with an alkali, or the like can be used. Among these methods, a method of irradiation with a plasma is preferred for efficiently activating the surfaces of the first bonding layer 151 and the second bonding layer 152. As the plasma, for example, oxygen, argon, nitrogen, air, water, and the like are used alone or in admixture of two or more kinds.

As shown in FIG. 4A, the first bonding layer 151 or the second bonding layer 152, each of which is a plasma-polymerized film before energy is applied, contains a Si skeleton 15B which contains a siloxane (Si—O) bond 15A and has a random atomic structure, and a leaving group 15C which binds to the Si skeleton 15B, and is a film which is easily deformed. The reason is considered to be that the crystallinity of the Si skeleton 15B is decreased, and therefore, a defect such as dislocation or shear in a crystal grain boundary is liable to occur.

When energy is applied to the first bonding layer 151 and the second bonding layer 152 each having such a structure, as shown in FIG. 4B, the leaving group 15C is released from the Si skeleton 15B. Due to this, an active hand 15D is generated on the surface and in the inside of the first bonding layer 151 and the second bonding layer 152, whereby activation is achieved. As a result, a bonding property is exhibited on the surfaces of the first bonding layer 151 and the second bonding layer 152. When such a bonding property is exhibited, the first bonding layer 151 and the second bonding layer 152 can be firmly bonded to each other. Incidentally, the crystallinity of the Si skeleton 15B of the first bonding layer 151 and the second bonding layer 152 is preferably 45% or less, more preferably 40% or less. If the crystallinity thereof falls within such a range, the Si skeleton 15B has a sufficiently random atomic structure, and as a result, the characteristics of the Si skeleton 15B become obvious.

The “activation” as used herein refers to a state where the leaving group 15C on the surface or in the inside of the first bonding layer 151 or the second bonding layer 152 is released, whereby a bonding hand which is not terminated (hereinafter also referred to as “non-bonding hand” or “dangling bond”) is generated in the Si skeleton 15B, or a state where the non-bonding hand is terminated by a hydroxy group (OH group), or a state where the both states are mixed together.

Accordingly, the active hand 150 refers to a non-bonding hand (dangling bond) or a hand in which a non-bonding hand is terminated by a hydroxy group, and such an active hand 15D can achieve firm bonding between the first bonding layer 151 and the second bonding layer 152.

### 3. Bonding Step

The polarizing layer 13 and the second substrate 12 are bonded to each other so as to integrate the members.

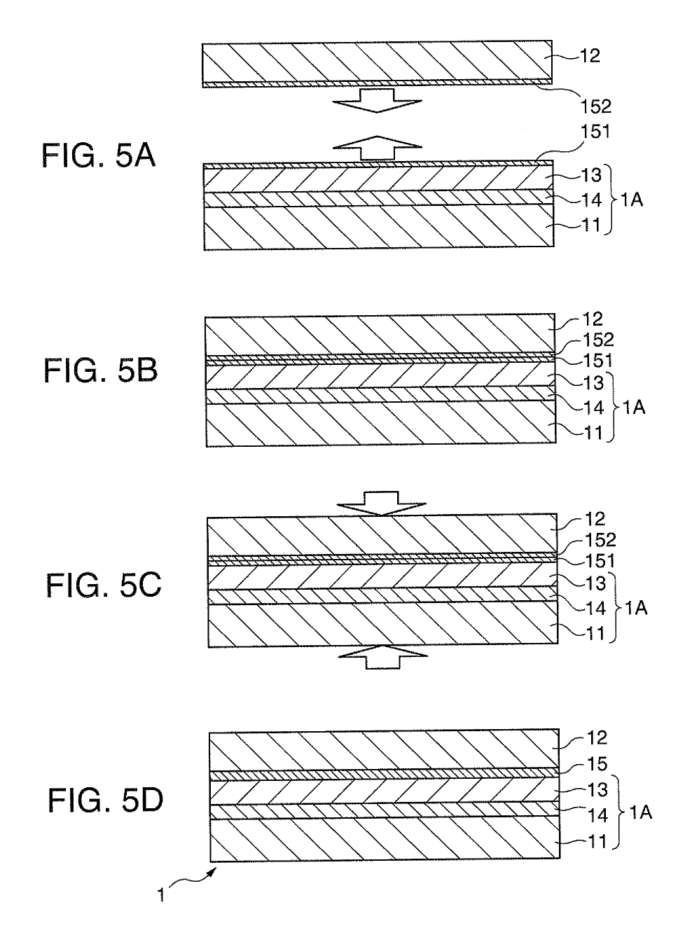

FIGS. 5A to 5D are views illustrating a bonding step.

First, as shown in FIG. 5A, the polarizing layer 13 and the second substrate 12 are pressed against each other in a state where the first bonding layer 151 and the second bonding layer 152 formed of the plasma-polymerized film face each other. Then, as shown in FIG. 5B, by bonding the first bonding layer 151 to the second bonding layer 152, these members are bonded to each other.

After the bonding step, as shown in FIG. 5C, the polarizing layer 13 and the second substrate 12 are pressurized, whereby as shown in FIG. 5D, the first bonding layer 151 and the second bonding layer 152 are integrated to become the second bonding film 15, whereby the optical device 1 is produced. After pressurizing the polarizing layer 13 and the second substrate 12, these members are heated. By this heating operation, the bonding strength can be increased. The resulting optical element 1 is appropriately diced.

The applied pressure during the pressurization is preferably 3 MPa or more, and the temperature during the pressurization is preferably 20° C. or higher and 50° C. or lower. If the temperature during the pressurization exceeds 50° C., the acrylic adhesive constituting the first bonding film 14 is plastically deformed due to heat, and the bonding film 14 runs off the outer periphery by the applied pressure. Therefore, it is preferred to pressurize the members at a temperature in a range in which the first bonding film 14 is not plastically deformed. Further, it is difficult to control the temperature lower than 20° C., and therefore, the temperature during the pressurization is preferably 20° C. or higher and 50° C. or lower. However, in the case of using an adhesive, the hardness of which can be maintained at a high temperature, it is possible to pressurize the members at a higher temperature.

Accordingly, in the first embodiment, the following operation and effect can be obtained.

(1) The optical device 1 according to the first embodiment is configured to include: the light transmissive first substrate 11; the light transmissive second substrate 12; the polarizing layer 13 disposed between the first substrate 11 and the second substrate 12; the first bonding film 14 which bonds the first substrate 11 to one principal surface of the polarizing layer 13; and the second bonding film 15 which bonds the second substrate 12 to the other principal surface of the polarizing layer 13, wherein the first bonding film 14 is an adhesive layer, and the second bonding film 15 contains a Si skeleton which has an atomic structure containing a siloxane (Si—O) bond and a leaving group which binds to the Si skeleton. Therefore, since the first bonding film 14 which bonds the first substrate 11 to one principal surface of the polarizing layer 13 is formed of an adhesive layer, a necessary strength can be ensured, and also the irregularities of the polarizing layer 13 made of a synthetic resin can be absorbed so as to prevent the incorporation of air bubbles, whereby the optical properties can be enhanced. Further, since the time of exposure of the polarizing layer 13 to heat generated by a plasma can be decreased, the deterioration or the like of the polarizing layer 13 can be prevented. Accordingly, the optical device 1 having a long life and excellent optical properties can be provided.

(2) In the second bonding film 15, a non-bonding hand (dangling bond) of the Si skeleton 15B from which the leaving group 15C is released becomes an active hand 15D to bond the second substrate 12 to the other principal surface of the polarizing layer 13, and therefore, such an active hand 15D can achieve firm bonding between the first bonding layer 151 and the second bonding layer 152 formed of the plasma-polymerized film, and the second substrate 12 and the polarizing layer 13 are not detached from each other.

(3) Since the second bonding film 15 is formed by a plasma polymerization method, the first bonding layer 151 and the second bonding layer 152, both of which are dense and homogeneous, can be formed, respectively. As a result, the polarizing layer 13 on which the first bonding layer 151 is formed and the second substrate 12 on which the second bonding layer 152 is formed can be reliably bonded to each other, and therefore, the second substrate 12 is not detached from the polarizing layer 13.

(4) If the polarizing layer 13 is formed of a polyvinyl alcohol, a polycarbonate, or a polyolefin, a polarizing plate can be easily produced because such a material is suitable for forming a polarizer.

(5) If the first substrate 11 and the second substrate 12 are formed of an inorganic material such as quartz crystal or sapphire, the heat radiation property is improved, and the heat resistance can be further improved as compared with the case where the substrates are formed of glass.

(6) Since the thickness of the second bonding film 15 is set to 300 nm or more and 700 nm or less, the irregularities of the polarizing layer 13 are absorbed, and air bubbles do not remain thereon. Further, the polarizing layer 13 is not shrunk or deformed due to the heat during film formation, and therefore, the outer appearance of the optical device 1 is enhanced. That is, if the thickness of the second bonding film 15 formed of a plasma-polymerized film is less than 300 nm, the irregularities of the polarizing layer 13 cannot be absorbed and fine air bubbles remain in a streaky form, and if the thickness of the second bonding film 15 exceeds 700 nm, due to the heat during the film formation, the polarizing layer is shrunk and deformed from an outer peripheral portion thereof, and therefore, bonding failure is liable to be caused in the outer peripheral portion thereof.

(7) In order to produce the optical device 1, the adhesion step of bonding the first substrate 11 to one principal surface of the polarizing layer 13 with an adhesive, the bonding layer formation step of forming the first bonding layer 151, which contains a Si skeleton 15B and a leaving group 15C that binds to the Si skeleton 15B, on the other principal surface of the polarizing layer 13 and forming the second bonding layer 152, which contains a Si skeleton 15B and a leaving group 15C that binds to the Si skeleton 15B, on the second substrate 12, the surface activation step of activating the first bonding layer 151 and the second bonding layer 152 formed in the bonding layer formation step, and the bonding step of bonding the polarizing layer 13 to the second substrate 12 so as to integrate the members are performed, and therefore, the optical device 1 can be efficiently produced.

(8) In particular, in this embodiment, the first bonding layer formation step of forming the first bonding layer 151 on the principal surface of the polarizing layer 13 and the second bonding layer formation step of forming the second bonding layer 152 on the principal surface of the second substrate 12 are performed, and therefore, the polarizing layer 13 and the second substrate 12 can be more reliably bonded to each other.

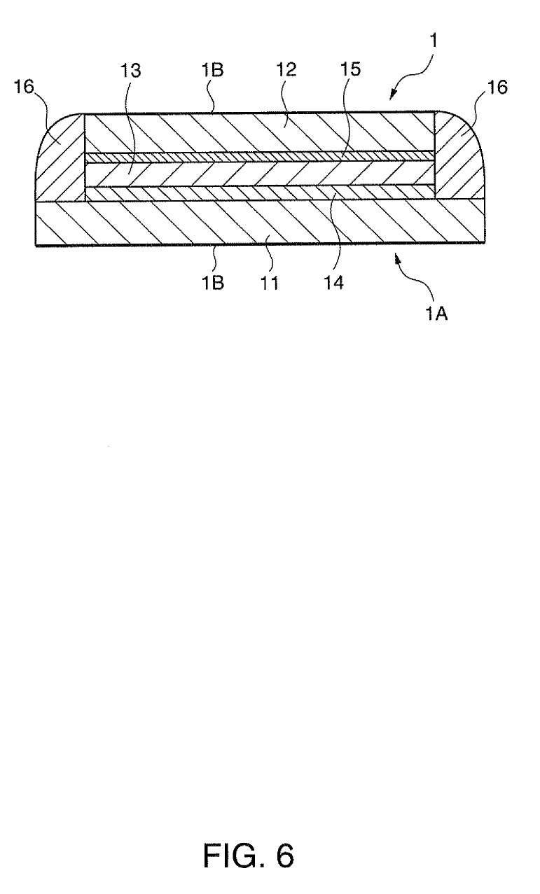

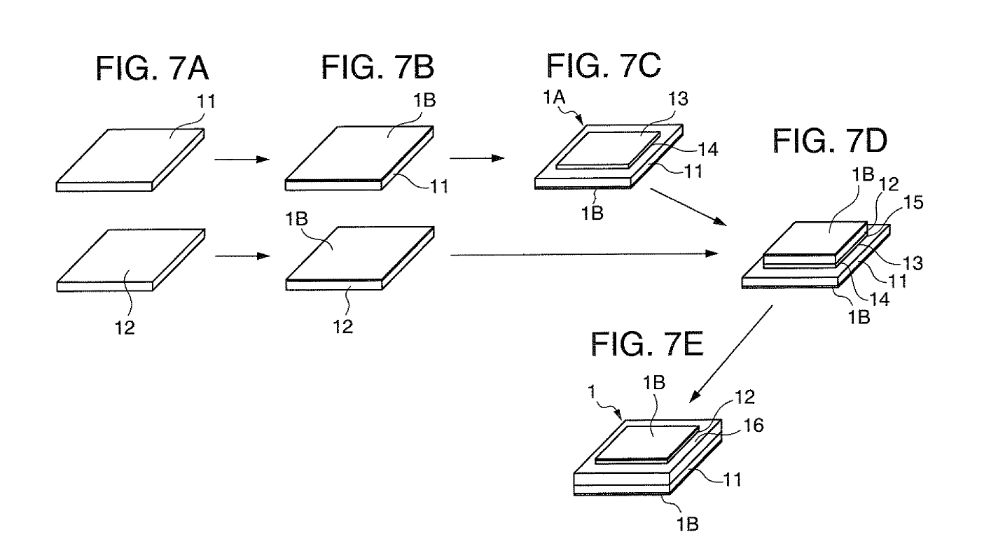

Next, a second embodiment according to the invention will be described with reference to FIGS. 6 to 7E.

The second embodiment is different from the first embodiment in the shape of the optical device, and the other configurations are the same as those of the first embodiment.

FIG. 6 is a cross section of an optical device 1 according to the second embodiment.

In FIG. 6, the optical device 1 is a polarizing plate provided with: a first substrate 11; a second substrate 12; a polarizing layer 13 as a synthetic resin layer; a first bonding film 14 which bonds the first substrate 11 to one principal surface of the polarizing layer 13; a second bonding film 15 which bonds the second substrate 12 to the other principal surface of the polarizing layer 13; and a sealing part 16 provided in an exposed portion of the polarizing layer 13, which is not in contact with the first bonding film 14 and the second bonding film 15.

In the second embodiment, the second substrate 12, the polarizing layer 13, the first bonding film 14, and the second bonding film 15 are formed such that the sizes of the plane surfaces thereof are smaller than that of the first substrate 11, and in a step portion formed by the lateral portions of the second substrate 12, the polarizing layer 13, the first bonding film 14, and the second bonding film 15 and the plane surface of the first substrate 11, the sealing part 16 is provided along all four sides of the first substrate 11.

On the outer surface of each of the first substrate 11 and the second substrate 12, an antireflection film 1B is formed. This antireflection film 1B is formed by forming a dielectric multilayer film by, for example, a sputtering process or a vacuum vapor deposition process in the same manner as in the first embodiment.

The sealing part 16 is formed of a sealant made of a material which has fluidity during processing and exhibits a sealing function by being cured after processing, for example, a sealant made of a UV curable resin, a thermosetting resin, a resin which is cured by UV and heat, or the like. Specific examples of such a sealant include thermosetting bonding agents such as ethylene-anhydride copolymers (epoxy resin-based bonding agents such as a thermosetting epoxy resin EP582 manufactured by Cemedine Co., Ltd., a UV curable epoxy resin KR695A manufactured by ADEKA Co., Ltd., a UV curable epoxy resin TB3025G manufactured by Three Bond Co., Ltd., and a UV curable resin XNR5516Z manufactured by Nagase ChemteX Corporation), urethane resin-based bonding agents, and phenol resin-based bonding agents; and UV curable bonding agents such as silicone resins (such as UV curable silicone resins, modified silicone resins having a silyl group-terminated polyether, cyanoacrylates, and acrylic resins).

A method for producing the optical device according to the second embodiment having this configuration will be described with reference to FIGS. 7A to 7E.

### 1. Adhesion Step

As shown in FIG. 7A, the first substrate 11 and the second substrate 12 are processed from quartz crystal, sapphire, or the like, and then, as shown in FIG. 7B, the antireflection film 1B is formed on one surface of the first substrate 11 and one surface of the second substrate 12. Then, as shown in FIG. 7C, the other surface of the first substrate 11 and the polarizing layer 13 are bonded to each other with an adhesive, whereby the polarizing plate unit 1A is produced. At this time, the first substrate 11 and the polarizing layer 13 are bonded to each other such that the center of the first substrate 11 coincides with the center of the polarizing layer 13, and a marginal portion where the polarizing layer 13 is not provided is formed in a peripheral portion of the first substrate 11.

### 2. Plasma-Polymerized Film Formation Step

Subsequently, as shown in FIG. 70, the second substrate 12 and the polarizing plate unit 1A are bonded to each other.

### 2-1. Bonding Layer Formation Step

The first bonding layer is formed by a plasma polymerization method on a plane surface of the polarizing layer 13 of the polarizing plate unit 1A, and the second bonding layer is formed by a plasma polymerization method on a plane surface of the second substrate 12. The procedure for forming the bonding layers is the same as in the first embodiment.

### 2-2. Surface Activation Step

The plasma-polymerized film formed in the bonding layer formation step is activated. Therefore, energy is applied to each of the first bonding layer and the second bonding layer formed of the plasma-polymerized film.

### 3. Bonding Step

The polarizing layer 13 and the second substrate 12 are bonded to each other so as to integrate the members. Therefore, the polarizing layer 13 and the second substrate 12 are pressed against each other in a state where the first bonding layer and the second bonding layer face each other. By doing this, the first bonding layer and the second bonding layer are bonded to each other, whereby the second bonding film 15 is formed. After the bonding step, the polarizing layer 13 and the second substrate 12 are pressurized.

### 4. Sealing Step

Subsequently, a sealant is applied by an applicator (not shown) to the step portion formed by the lateral surfaces of the second substrate 12, the second bonding film 15, the polarizing layer 13, and the first bonding film 14, and the marginal portion of the first substrate 11. By doing this, the sealing part 16 is formed on the periphery of the second substrate 12, the second bonding film 15, the polarizing layer 13, and the first bonding film 14.

Accordingly, in the second embodiment, not only the operation and effect described in (1) to (8) of the first embodiment, but also the following operation and effect can be obtained.

(9) Since the sealing part 16 for sealing with a sealant is provided in the lateral portions of the polarizing layer 13, the first bonding film 14, the second bonding film 15, and the second substrate 12, the both plane surfaces of the polarizing layer 13 are covered with the first bonding film 14 and the second bonding film 15, and also the four lateral surfaces thereof are sealed by the sealing part 16. Therefore, not only is the heat resistance further improved, but also dew condensation is not caused. As a result, poor appearance can be prevented from occurring, and also deterioration of the transmissibility can be prevented because dew condensation is not caused. In this embodiment, it is only necessary to provide the sealing part 16 for sealing with a sealant at least in an exposed portion of the polarizing layer 13, which is not in contact with the first bonding film 14 and the second bonding film 15. Also in this case, the polarizing layer 13 is sealed by the sealing part 16 so that the end portion thereof does not come into contact with the air, and therefore, not only is the heat resistance further improved, but also dew condensation is not caused. Accordingly, poor appearance is not caused and the transmissibility is not adversely affected.

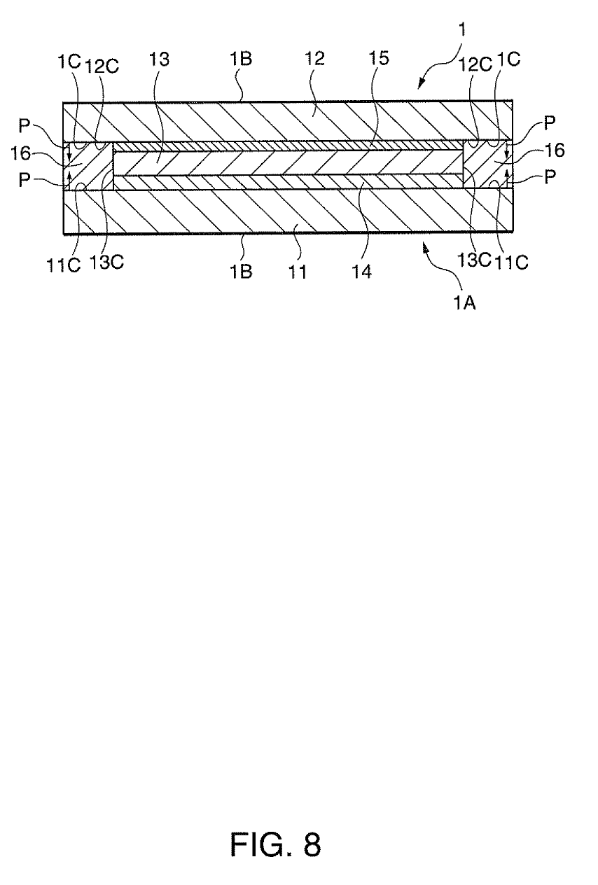

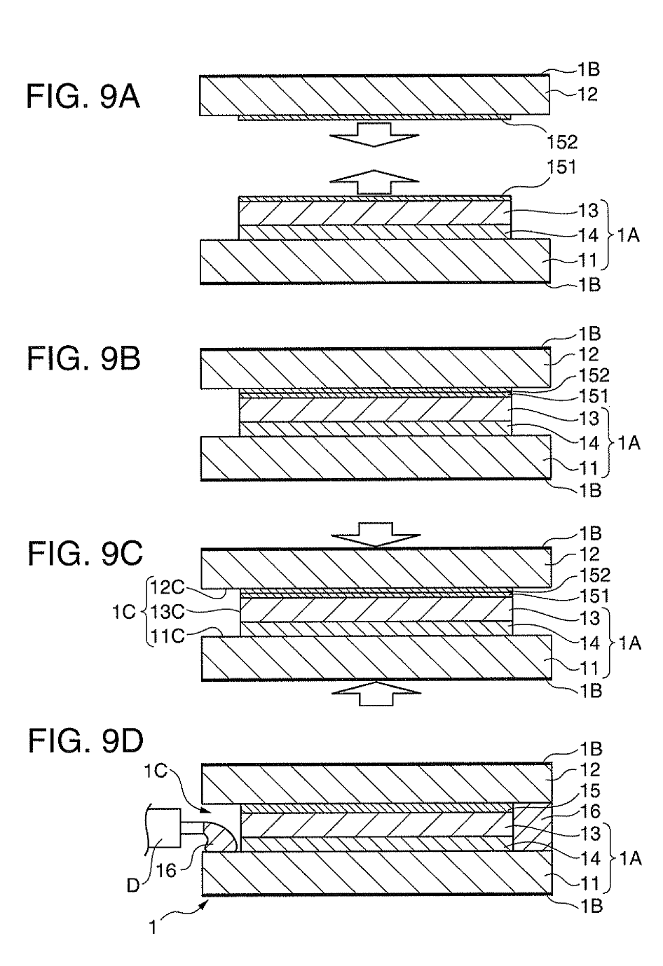

Next, a third embodiment of the invention will be described with reference to FIGS. 8 to 9D.

The third embodiment is different from the second embodiment in the size of the second substrate 12, and the other configurations are the same as those of the second embodiment.

FIG. 8 is a cross section of an optical device 1 according to the third embodiment.

In FIG. 8, the optical device 1 is a polarizing plate provided with: a first substrate 11; a second substrate 12 which has the same outer shape as the first substrate 11; a polarizing layer 13 as a resin layer; a first bonding film 14 which bonds the first substrate 11 to one principal surface of the polarizing layer 13; a second bonding film 15 which bonds the second substrate 12 to the other principal surface of the polarizing layer 13; and a sealing part 16 provided in a recess 1C formed by a plane surface 11C of an end portion of the first substrate 11 facing the second substrate 12, a plane surface 12C of an end portion of the second substrate 12 facing the first substrate 11, and lateral surfaces 13C of the polarizing layer 13, the first bonding film 14, and the second bonding film 15. On the outer surface of each of the first substrate 11 and the second substrate 12, an antireflection film 1B is formed. As the antireflection film 1B to be used in this embodiment, an antireflection film formed of a single layer of MgF₂ by thermal vapor deposition or an antireflection film obtained by laminating ZrO₂ (having a high refractive index) and MgF₂ (having a low refractive index) can be exemplified.

The first substrate 11 and the second substrate 12 are disposed such that the four corners of both substrates coincide with each other, respectively, in a plan view. Further, the polarizing layer 13, the first bonding film 14, and the second bonding film 15 are disposed such that the four corners of these members coincide with one another, respectively, in a plan view. The recess 1C is formed continuously on the four sides of the first substrate 11 and the second substrate 12. The outer lateral surface of the sealing part 16 coincides with those of the first substrate 11 and the second substrate 12.

The dimension from the edge of each of the plane surfaces of 11C and 12C to the lateral surfaces 13C of the polarizing layer 13, the first bonding film 14, and the second bonding film 15 can be appropriately set, however, the dimension is preferably 0.2 mm or more and 2.0 mm or less. If this dimension is too short, the sealing effect or the effect of the bonding strength is small, and if this dimension is too long, an optically effective range becomes too narrow. Further, the dimension of the thickness of each of the polarizing layer 13, the first bonding film 14, and the second bonding film 15 is the same as in the first embodiment, and the dimension of the lateral surfaces 13C is 25.3 μm or more and 55.7 μm or less.

The sealing part 16 is formed by sealing the recess 10 with a cure-shrinkable bonding agent as the sealant. In the same manner as the sealing part 16 of the second embodiment, the cure-shrinkable bonding agent is formed of a sealant which has fluidity during processing and is cured after processing, for example, a bonding agent made of a UV curable resin, a thermosetting resin, a resin which is cured by UV and heat, or the like. In the sealing part 16, when the sealant is cured, a tensile stress P in the inward direction is generated so that the end portion of the first substrate 11 and the end portion of the second substrate 12 come close to each other. The sealing part 16 is provided throughout the periphery of the four sides of the first substrate 11 and the second substrate 12 along the recess 1C.

The cure-shrinkage ratio of the cure-shrinkable bonding agent to be used in this embodiment is 1% or more and 15% or less, preferably 1.5% or more and 10% or less, more preferably 2% or more and 9% or less. If the cure-shrinkage ratio is less than 1%, the effect of shrinkage is low, and if the cure-shrinkage ratio exceeds 15%, a residual stress becomes too large and detachment may be caused.

Specific examples of the cure-shrinkable bonding agent to be used in this embodiment include bonding agents described in the second embodiment and also include a UV curable resin XNR5541 manufactured by Nagase ChemteX Corporation and WR (WORLD ROCK) 8725 manufactured by Kyoritsu Chemical & Co., Ltd.

XNR5541 is colorless and transparent, and has a high bonding property. This bonding agent contains an epoxy resin as a main component, has a liquid refractive index at 20° C. of 1.535, a viscosity at 25° C. of 450 mPa·s, a Tg (DMA) of 104° C., and a linear expansion coefficient (TMA) of 73 ppm/° C., and is cured under the curing condition of 1 J/cm²+100° C./1 h.

A method for producing the optical device according to the third embodiment having this configuration will be described with reference to FIGS. 9A to 9D.

### 1. Adhesion Step

First, the first substrate 11 and the second substrate 12 are processed from quartz crystal, sapphire, or the like, and then, the antireflection film 1B is formed on one surface of the first substrate 11 and one surface of the second substrate 12.

Then, the other surface of the first substrate 11 and the polarizing layer 13 are bonded to each other with an adhesive, whereby the polarizing plate unit 1A is produced. At this time, the first substrate 11 and the polarizing layer 13 are bonded to each other such that the center of the first substrate 11 coincides with the center of the polarizing layer 13, and a marginal portion where the polarizing layer 13 is not provided is formed in a peripheral portion of the first substrate 11. This peripheral portion forms a part of the recess 1C.

### 2. Plasma-Polymerized Film Formation Step

Subsequently, the second substrate 12 and the polarizing plate unit 1A are bonded to each other.

### 2-1. Bonding Layer Formation Step

The first bonding layer is formed by a plasma polymerization method on a plane surface of the polarizing layer 13 of the polarizing plate unit 1A, and the second bonding layer is formed by a plasma polymerization method on a plane surface of the second substrate 12. The second bonding layer is formed to have the same size as the first bonding layer. The procedure for forming the bonding layers is the same as in the first embodiment.

### 2-2. Surface Activation Step

The plasma-polymerized film formed in the bonding layer formation step is activated. Therefore, energy is applied to each of the first bonding layer and the second bonding layer formed of the plasma-polymerized film.

### 3. Bonding Step

The polarizing layer 13 and the second substrate 12 are bonded to each other so as to integrate the members.

FIGS. 9A to 9D are views illustrating the bonding step.

First, as shown in FIG. 9A, the polarizing layer 13 and the second substrate 12 are pressed against each other in a state where the first bonding layer 151 and the second bonding layer 152 formed of the plasma-polymerized film face each other. Then, as shown in FIG. 95, by bonding the first bonding layer 151 to the second bonding layer 152, these members are bonded to each other.

After the bonding step, as shown in FIG. 9C, the polarizing layer 13 and the second substrate 12 are pressurized, whereby as shown in FIG. 9D, the first bonding layer 151 and the second bonding layer 152 are integrated to become the second bonding film 15. In this state, the recess 1C is formed by a plane surface 11C of an end portion of the first substrate 11, a plane surface 12C of an end portion of the second substrate 12, and lateral surfaces 13C of the polarizing layer 13, the first bonding film 14, and the second bonding film 15.

### 4. Sealing Part Formation Step

As shown in FIG. 90, a bonding agent is supplied by a dispenser D to a region on the lateral surface of the polarizing layer 13, interposed between the first substrate 11 and the second substrate 12, i.e., the recess 1C, and the sealing part 16 is formed into a circular shape. The bonding agent may be supplied to the recess 1C along the four sides separately of the first substrate 11 and the second substrate 12, but may be supplied at one site or a plurality of specific sites. In this embodiment, since the dimension of the lateral surfaces 13C of the polarizing layer 13, the first bonding film 14, and the second bonding film 15 is smaller than those of the plane surfaces 11C and 12C, the bonding agent spreads over every corner of the recess 1C by a capillary phenomenon. Accordingly, the outer peripheral surface of the sealing part 16 formed by applying the bonding agent substantially coincide with the outer lateral surfaces of the first substrate 11 and the second substrate 12.

The sealing part 16 formed in the recess 1C is irradiated with ultraviolet light (UV), whereby the bonding agent which forms the sealing part 16 is cured.

As an apparatus to be used for the irradiation with UV, for example, a UV irradiation apparatus manufactured by Fusion UV Systems, Inc. can be used. By using this UV irradiation apparatus, the bonding agent was irradiated with UV under the conditions that a conveyor speed was 1.7 m/sec, the number of reciprocating motions was 2, and a cumulative light quantity was 2096 mJ/cm² (at 365 nm).

By curing the bonding agent, a force of inward shrinking acts in the sealing part 16, and a force is generated such that the end portion of the first substrate 11 and the end portion of the second substrate 12 come close to each other. Therefore, the polarizing layer 13, the first bonding film 14, and the second bonding film 15 are sandwiched by the first substrate 11 and the second substrate 12.

By these steps, the optical device 1 is produced.

Accordingly, in the third embodiment, not only the operation and effect described in (1) to (9) of the second embodiment, but also the following operation and effect can be obtained.

(10) Since the outer shapes of the first substrate 11 and the second substrate 12 are larger than that of the polarizing layer 13, and the sealing part 16 for sealing with a sealant is provided in the recess 1C, which is a region on the lateral surface of the polarizing layer 13, interposed between the first substrate 11 and the second substrate 12, the second substrate 12 and the polarizing layer 13 are bonded to each other through the second bonding film 15 formed of a plasma-polymerized film, and further, even if an end portion of the first substrate 11 or the second substrate 12 is going to be detached from an end portion of the polarizing layer 13 or the like due to the formation of the antireflection film 1B on the surface of each of the first substrate 11 and the second substrate 12, the polarizing layer 13, the first bonding film 14, and the second bonding film 15 are sandwiched by the first substrate 11 and the second substrate 12 by means of the sealing part 16, and therefore, the detachment is prevented. In particular, in this embodiment, since the sealing part 16 is provided throughout the periphery of the first substrate 11 and the second substrate 12, even if the first substrate 11 or the second substrate 12 is going to be detached from the polarizing layer 13 or the like at any point, the detachment can be reliably prevented.

(11) Since the sealant is a cure-shrinkable bonding agent, when the bonding agent shrinks after the recess 1C is sealed with the bonding agent, a force acts in such a direction that an end portion of the first substrate 11 and an end portion of the second substrate 12 come close to each other, and therefore, the detachment of the first substrate 11 or the second substrate 12 from the polarizing layer 13 can be more effectively prevented.

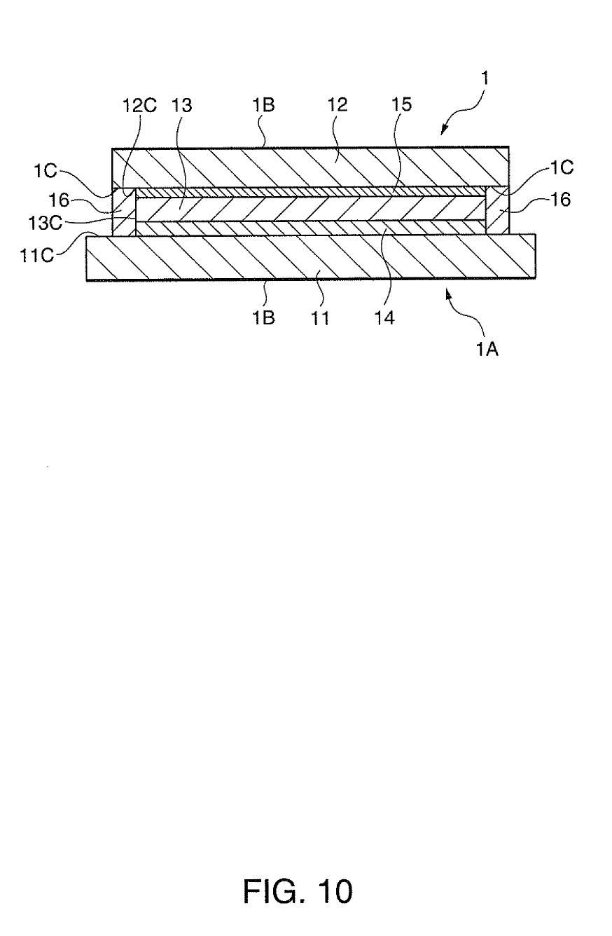

Next, a fourth embodiment of the invention will be described with reference to FIG. 10.

The fourth embodiment is different from the third embodiment in the size of the outer shape of the second substrate 12, and the other configurations are the same as those of the third embodiment.

FIG. 10 is a cross section of an optical device 1 according to the fourth embodiment.

In FIG. 10, the optical device 1 is a polarizing plate provided with: a first substrate 11; a second substrate 12 which is smaller than the first substrate 11; a polarizing layer 13; a first bonding film 14 which bonds the first substrate 11 to one principal surface of the polarizing layer 13; a second bonding film 15 which bonds the second substrate 12 to the other principal surface of the polarizing layer 13; and a sealing part 16 provided in a recess 1C formed by a plane surface 11C of an end portion of the first substrate 11 facing the second substrate 12, a plane surface 12C of an end portion of the second substrate 12 facing the first substrate 11, and lateral surfaces 130 of the polarizing layer 13, the first bonding film 14, and the second bonding film 15.

The first substrate 11 and the second substrate 12 are similar in shape in a plan view, and the sealing part 16 is not provided in a portion of the first substrate 11 which is larger than the second substrate 12, and the portion becomes an exposed end portion. This exposed end portion is a mounting portion which can be held by a housing (not shown) constituting an apparatus such as an electronic apparatus. In this embodiment, the optical device may be configured such that the second substrate 12 is larger than the first substrate 11. In this case, the outer lateral surface of the sealing part 16 coincides with that of the first substrate 11.

Accordingly, in the fourth embodiment, not only the operation and effect described in (1) to (11) of the third embodiment, but also the following operation and effect can be obtained.

(12) Since the outer shape of one of the first substrate 11 and the second substrate 12 is larger than that of the other one, a portion which is an end portion of one of the first substrate 11 and the second substrate 12 and protrudes from the other one becomes a mounting portion in the apparatus, and therefore, the mounting operation of the optical device 1 becomes easy. Further, even if a large amount of a bonding agent is supplied to the recess 1C, the bonding agent is retained on a larger one of the plane surfaces of the first substrate 11 and the second substrate 12. Accordingly, poor appearance due to leakage of the bonding agent from the optical device 1 is not caused.

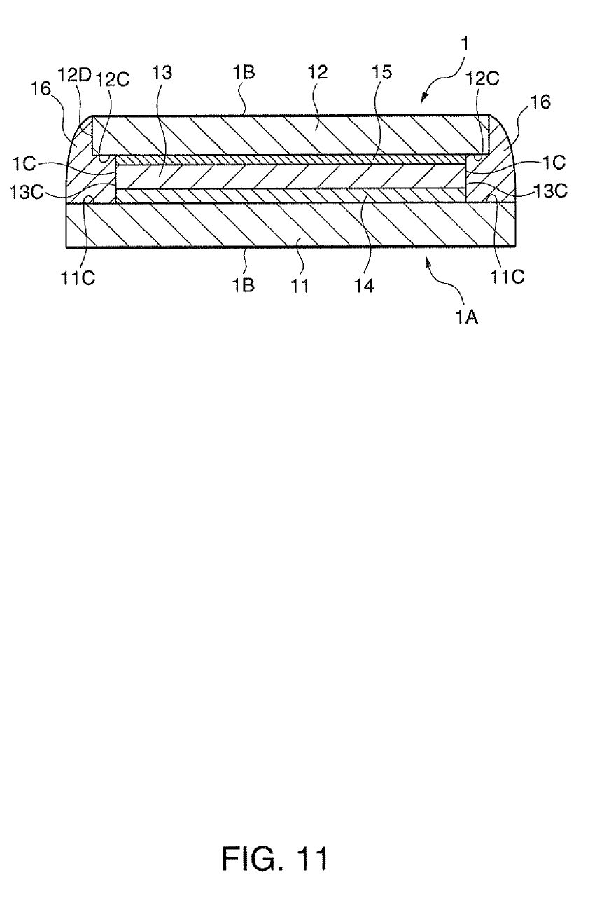

Next, a fifth embodiment of the invention will be described with reference to FIG. 11.

The fifth embodiment is different from the forth embodiment in the shape of the sealing part, and the other configurations are the same as those of the fourth embodiment.

FIG. 11 is a cross section of an optical device 1 according to the fifth embodiment.

In FIG. 11, the optical device 1 is a polarizing plate provided with: a first substrate 11; a second substrate 12 which has a smaller outer shape than the first substrate 11; a polarizing layer 13; a first bonding film 14; a second bonding film 15; and a sealing part 16. The sealing part 16 is formed by attaching a bonding agent to a recess 1C formed by a plane surface 11C of an end portion of the first substrate 11, a plane surface 12C of an end portion of the second substrate 12, and lateral surfaces 13C of the polarizing layer 13, the first bonding film 14, and the second bonding film 15, and also to an outer lateral surface 12D of the second substrate 12. The outer lateral surface of the sealing part 16 gently curves from an outside edge of a surface on which an antireflection film 1B is formed to an outside edge on which the plane surface 11C of the substrate 11 is formed.

In the formation of the sealing part 16, a method in which after the bonding agent is supplied to the recess 1C by a dispenser D, the bonding agent is additionally added to the outside of the bonding agent with which the recess 1C is closed can be adopted.

Accordingly, in the fifth embodiment, not only the operation and effect described in (1) to (11) of the third embodiment, but also the following operation and effect can be obtained.

(13) Since the sealant is attached to the outer lateral surface 120 of the second substrate 12, the sealing part 16 is provided not only in the recess 1C, but also on the outer lateral surface 12D of the second substrate 12, and therefore, a larger sealing effect can be obtained.

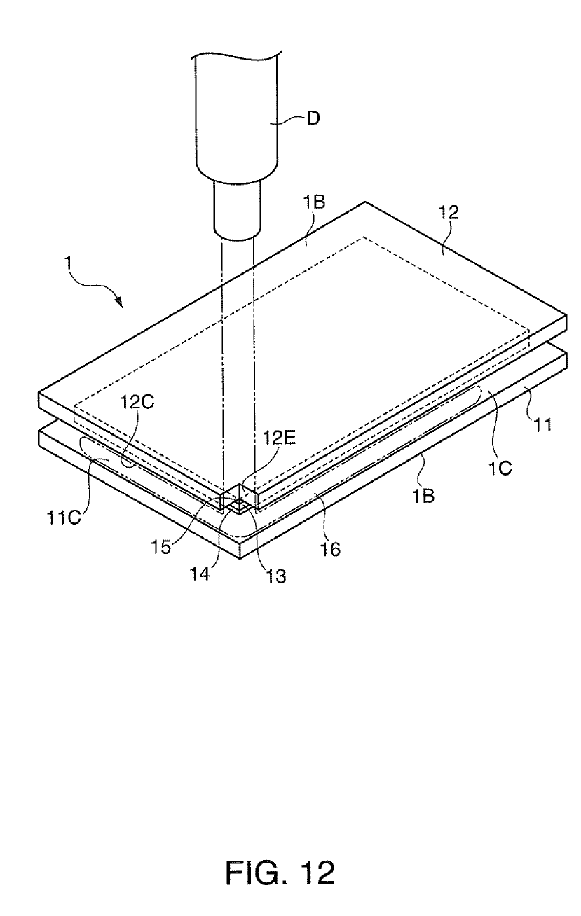

Next, a sixth embodiment of the invention will be described with reference to FIG. 12.

The sixth embodiment is different from the third embodiment in the shape of the second substrate 12 and the method for producing an optical device, and the other configurations are the same as those of the third embodiment.

FIG. 12 is a perspective view showing a process for producing an optical device according to the sixth embodiment.

In FIG. 12, the optical device 1 is a polarizing plate provided with: a first substrate 11; a second substrate 12 which has a smaller outer shape than the first substrate 11; a polarizing layer 13; a first bonding film 14; a second bonding film 15; and a sealing part 16. At one corner of the second substrate 12, a notch 12E which has an L shape in a plan view is formed. This notch 12E may be formed at one site, but may be formed at a plurality of given sites, for example, at the four corners of the second substrate 12. In addition, the shape of the notch 12E is not limited, and for example, the shape may be an arc, and also the notch 12E may be formed into a through hole which has a circular shape or a rectangular shape in a plan view.

In the sixth embodiment having this configuration, the method for producing an optical device is the same as that in the third embodiment, however, the sealing part formation step is different from that in the third embodiment. That is, in this embodiment, the dispenser D is disposed on the upper side of the notch 12E of the second substrate 12, and from the dispenser D, the bonding agent is supplied to the plane surface of the first substrate 11 through the notch 12E. As a result, the bonding agent spreads over every corner of the recess 1C by a capillary phenomenon.

Accordingly, in the sixth embodiment, not only the operation and effect described in (1) to (11) of the third embodiment, but also the following operation and effect can be obtained.

(14) Since the notch 12E is formed at a corner of the second substrate 12 and the bonding agent is supplied to the plane surface of the first substrate 11 from the dispenser disposed on the upper side of the notch 12E, there is no restriction on the place where the dispenser D is disposed unlike the third embodiment, and therefore, an optical device can be easily produced. In addition, by forming the notch 12E only in the second substrate 12, the front and rear surfaces of the optical device 1 can be easily distinguished from each other.

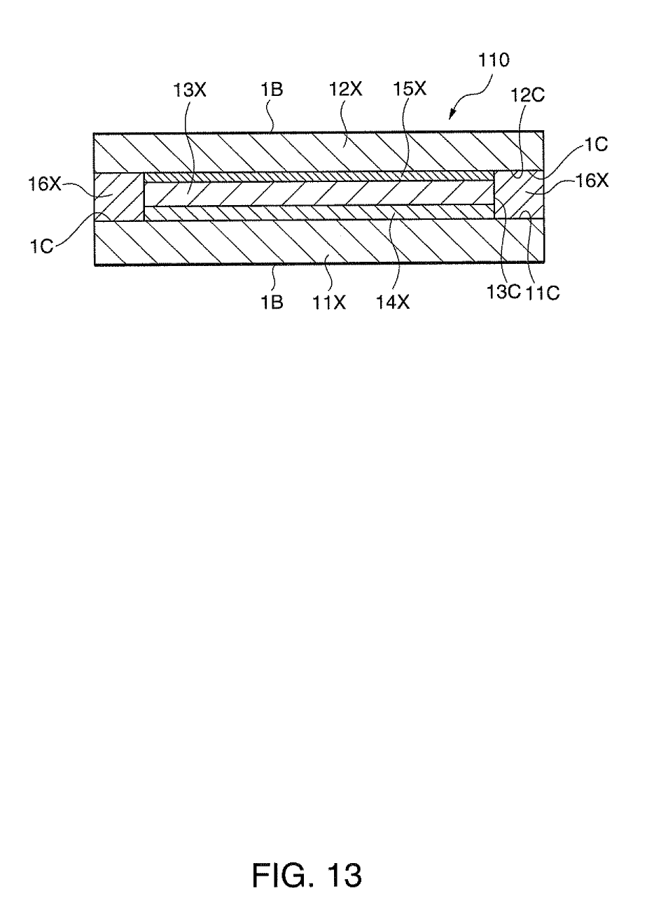

Next, a seventh embodiment of the invention will be described with reference to FIG. 13.

The seventh embodiment is an example of an optical device which is an optical low-pass filter.

FIG. 13 is a cross section of an optical device according to the seventh embodiment.

In FIG. 13, the optical device 110 is an optical low-pass filter provided with: a first substrate 11X; a second substrate 12X which has the same size as that of the first substrate 11X; a retardation element 13X as a resin layer; a first bonding film 14X which bonds the first substrate 11X to one principal surface of the retardation element 13X; a second bonding film 15X which bonds the second substrate 12X to the other principal surface of the retardation element 13X; and a sealing part 16X provided in a recess 1C formed by a plane surface 110 of an end portion of the first substrate 11X facing the second substrate 12X, a plane surface 120 of an end portion of the second substrate 12C facing the first substrate 11X, and lateral surfaces 130 of the retardation element 13X, the first bonding film 14X, and the second bonding film 15X. This optical low-pass filter is used in an image pickup apparatus (which has COD, CMOS, or the like).

The first substrate 11X and the second substrate 12X are each a birefringent plate composed of quartz crystal. The retardation element 13X functions as a ¼ wavelength plate.

The method for producing an optical device according to the seventh embodiment is the same as that in the third embodiment.

Accordingly, in the seventh embodiment, not only the operation and effect described in (1) to (11) of the third embodiment, but also the following operation and effect can be obtained.

(15) Since the optical device 110 is provided with: the first substrate 11X which is a birefringent plate composed of quartz crystal; the second substrate 12X which is a birefringent plate composed of quartz crystal and has the same size as that of the first substrate 11X; the retardation element 13X as a resin layer; the first bonding film 14X which bonds the first substrate 11X to one principal surface of the retardation element 13X; the second bonding film 15C which bonds the second substrate 12X to the other principal surface of the retardation element 13X; and the sealing part 16X provided in a recess 1C formed by a plane surface 110 of an end portion of the first substrate 11X facing the second substrate 12X, a plane surface 120 of an end portion of the second substrate 12X facing the first substrate 11X, and lateral surfaces 13C of the retardation element 13X, the first bonding film 14X, and the second bonding film 15X, it is possible to provide an optical low-pass filter in which the detachment of the first substrate 11X or the second substrate 12X from the retardation element 13X or the like can be prevented.

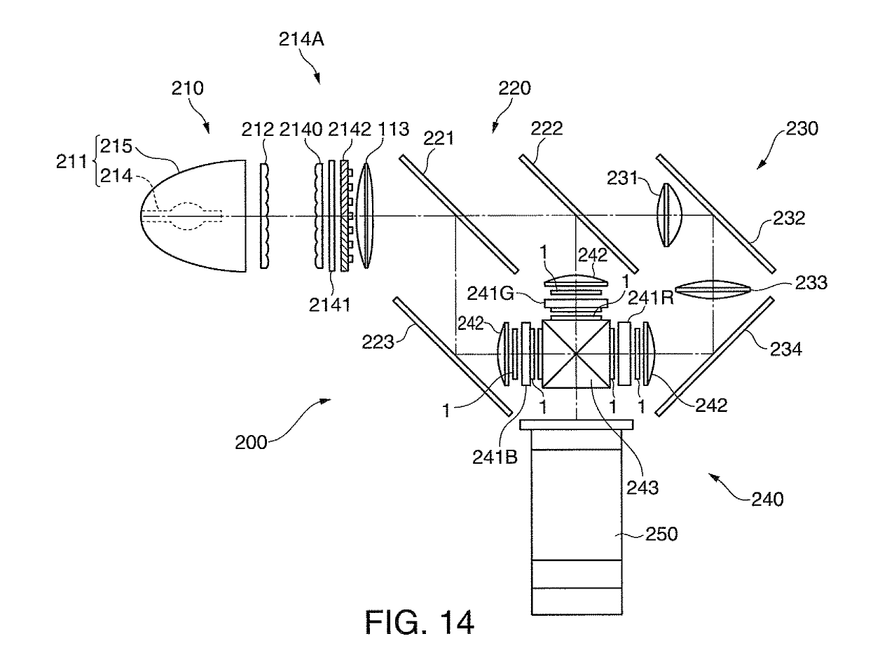

Next, an eighth embodiment will be described with reference to FIG. 14.

The eighth embodiment is an example of applying the optical device according to any of the first to sixth embodiments to a projection-type imaging apparatus (liquid crystal projector).

FIG. 14 is a view showing a schematic structure of a projection-type imaging apparatus.

In FIG. 14, a projection-type imaging apparatus 200 is provided with an integrator illumination optical system 210, a color separation optical system 220, a relay optical system 230, a light modulator 240 which modulates light emitted from a light source according to image information, and a projection optical device 250 which enlarges and projects the light modulated by the light modulator 240.

The integrator illumination optical system 210 is an optical system for substantially uniformly illuminating image forming regions of three transmissive liquid crystal panels 241R, 241G, and 241B, which will be described later, and is provided with a light source device 211, a first lens array 212, a superposition lens 113, and a polarization converter 214A.

The light source device 211 reflects a radial light beam emitted from a light source lamp 214 with a reflector 215 to form a substantially parallel light beam, and then emits the substantially parallel light beam to the outside.

The polarization converter 214A is provided with a second lens array 2140, a light shielding plate 2141, and a polarization conversion element 2142.

The color separation optical system 220 is provided with two dichroic mirrors 221 and 222 and a reflecting mirror 223, and separates a plurality of light beams emitted from the integrator illumination optical system 210 into light beams of three colors of red, green, and blue by the dichroic mirrors 221 and 222. A blue light component separated by the dichroic mirror 221 is reflected by the reflecting mirror 223, and then passes through a field lens 242 and reaches the transmissive liquid crystal panel 241B for blue.

Among a red light component and a green light component transmitted through the dichroic mirror 221, the green light component is reflected by the dichroic mirror 222, and then passes through the field lens 242 and reaches the transmissive liquid crystal panel 241G for green.

The relay optical system 230 is provided with an incident side lens 231, a relay lens 233, and reflecting mirrors 232 and 234. The red light component separated by the color separation optical system 220 is transmitted through the dichroic mirror 222, and then passes through the relay optical system 230 and further passes through the field lens 242 and reaches the transmissive liquid crystal panel 241R for red light.

The light modulator 240 is provided with the transmissive liquid crystal panels 241R, 241G, and 241B, and a cross dichroic prism 243. The cross dichroic prism 243 combines optical images each modulated for each color light and forms a color optical image.

Three optical devices 1 on an incident side (side of the light source) and three optical devices 1 on an exit side (side of the cross dichroic prism) are arranged so as to sandwich the transmissive liquid crystal panels 241R, 241G, and 241B, respectively.

Each optical device 1 is arranged such that the second substrate 12 is disposed on a light incident side and the first substrate 11 is disposed on a light exit side. In this embodiment, it is necessary to arrange the optical device 1 on both sides of the transmissive liquid crystal panel 241B, however, it is not always necessary to arrange the optical device 1 on both sides of the transmissive liquid crystal panel 241G or 241R.

Accordingly, in the eighth embodiment, not only the same operation and effect as those described in (1) to (14) of the first to sixth embodiments, but also the following operation and effect can be obtained.

(16) The projection-type imaging apparatus 200 is configured to include: the light source lamp 214; the light modulator 240 which modulates light from the light source lamp 214; the projection optical device 250 which projects the light modulated by the light modulator 240; and the optical device 1 as the polarizing plate disposed between the light modulator 240 and the light source lamp 214. Therefore, by using the optical device 1 having high transmissibility, the projection-type imaging apparatus 200 having high projection accuracy can be provided.

(17) The optical device 1 is arranged such that the second substrate 12 is disposed on a light incident side and the first substrate 11 is disposed on a light exit side. That is, the second bonding film 15 formed of a plasma-polymerized film is disposed at a position closer to the light source lamp 214 than the first bonding film 14 formed of an adhesive, and therefore, even if the optical device 1 is irradiated with light from the light source lamp 214 at a high illumination intensity, the deterioration of the adhesive due to heat or light can be prevented.

(18) The light modulator 240 is configured to include the transmissive liquid crystal panels 241R, 241G, and 2415, and therefore, also in view of this, the projection-type imaging apparatus 200 having high projection accuracy can be provided.

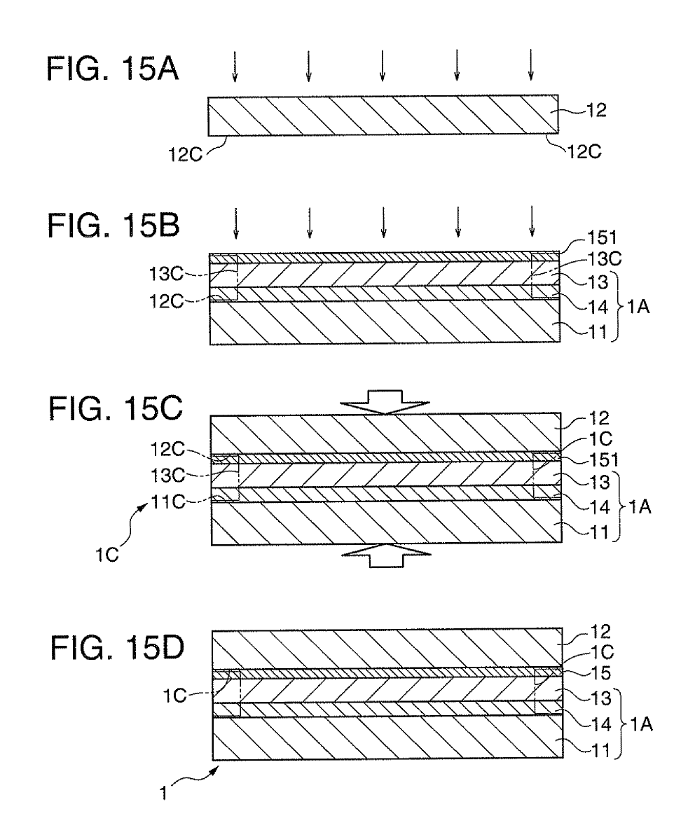

Next, the method for producing an optical device according to a ninth embodiment of the invention will be described with reference to FIGS. 15A to 15D. FIGS. 15A to 15D are schematic views showing a procedure for producing an optical device according to the ninth embodiment of the invention.

In the first embodiment, the first bonding layer 151 and the second bonding layer 152 are formed on a principal surface of the polarizing layer 13 and a principal surface of the second substrate 12, respectively, however, in this embodiment, the first bonding layer is formed on one of the polarizing layer 13 and the second substrate 12.

That is, in the ninth embodiment, the first bonding layer 151 containing a Si skeleton 155 and a leaving group 15C which binds to the Si skeleton 155 is formed only on the other principal surface of the polarizing layer 13, and the other principal surface of the polarizing layer 13 and the second substrate 12 are bonded to each other through the first bonding layer 151.

First, in the same manner as the above-described embodiments, the first substrate 11 and the polarizing layer 13 are bonded to each other with an adhesive, whereby the polarizing plate unit 1A is formed, and then, the first bonding layer 151 is formed on a principal surface of the polarizing layer 13.

Thereafter, in order to increase the adhesiveness between the first bonding layer 151 and the second substrate 12, one or both of the bonding surfaces of the first bonding layer 151 and the second substrate 12 is/are subjected to a surface treatment.

As shown in FIG. 15A, the bonding surface of the second substrate 12 is subjected to a surface activation treatment according to a constituent material of the substrate. Examples of the surface activation treatment include physical surface treatments such as a sputtering treatment and a blast treatment; and chemical surface treatments such as a plasma treatment using oxygen plasma, nitrogen plasma, or the like, a corona discharge treatment, an etching treatment, an electron beam irradiation treatment, an ultraviolet irradiation treatment, and an ozone exposure treatment.

As shown in FIG. 15B, the bonding surface of the first bonding layer 151 is subjected to a surface activation treatment in the same manner as described above. Incidentally, as the surface treatment for the second substrate 12, a treatment for activation similar to the surface activation treatment as described above performed for the first bonding layer 151 formed on the other principal surface of the polarizing layer 13 can be adopted.

Thereafter, as shown in FIG. 150, the polarizing layer 13 and the second substrate 12 are pressurized. By doing this, as shown in FIG. 15D, the optical device 1 is produced.

Incidentally, in the production of the optical device according to the third embodiment, as indicated by an imaginary line in FIG. 15B, the polarizing layer 13, the first bonding film 14, and the first bonding layer 151 are formed smaller in area than the first substrate 11, and as shown in FIG. 150, the second substrate 12 is disposed on the first bonding layer 151, and these members are pressurized. In this step, since the recess 1C is formed, the sealing part 16 is formed by supplying the bonding agent to this recess 1C.

Accordingly, in the ninth embodiment, not only the same operation and effect as those described in (1) to (14) of the first to sixth embodiments, but also the following operation and effect can be obtained.

(19) Since the method includes the surface activation step of activating the principal surface on which the first bonding layer 151 is not formed among the other principal surface of the polarizing layer 13 and a principal surface of the second substrate 12, the polarizing layer 13 and the second substrate 12 can be bonded to each other by simplifying the plasma-polymerized film formation step.

### EXAMPLES

Next, in order to confirm the effects of the above-described embodiments, Examples will be described. In the present Examples, conditions for forming the second bonding film 15 by a plasma polymerization method and effects thereof were confirmed.

### Example 1

The substrate temperature during film formation was 65° C., the thickness of the second bonding film 15 formed of a plasma-polymerized film was 500 nm, the temperature during pressurization was 35° C., and the applied pressure was 30 MPa. The outer appearance of the optical device 1 produced under such conditions was favorable.

### Example 2

The substrate temperature during film formation was 85° C., the thickness of the second bonding film 15 was 500 nm, the temperature during pressurization was 35° C., and the applied pressure was 30 MPa. The outer appearance of the optical device 1 produced under such conditions was favorable.

### Comparative Example 1

The substrate temperature during film formation was 60° C., the thickness of the second bonding film 15 was 500 nm, the temperature during pressurization was 35° C., and the applied pressure was 30 MPa. In the optical device 1 produced under such conditions, fine air bubbles remained in the polarizing layer 13 in the form of a film.

### Comparative Example 2

The substrate temperature during film formation was 90° C., the thickness of the second bonding film 15 was 500 nm, the temperature during pressurization was 35° C., and the applied pressure was 30 MPa. In the optical device 1 produced under such conditions, an outer peripheral portion of the polarizing layer 13 in the form of a film was shrunk and deformed, and bonding failure was caused.

As described above, from the experimental results of Examples 1 and 2 and Comparative Examples 1 and 2, it is found that the substrate temperature during film formation is preferably 65° C. or higher and 85° C. or lower.

### Example 3

The substrate temperature during film formation was 85° C., the thickness of the second bonding film 15 was 300 nm, the temperature during pressurization was 35° C., and the applied pressure was 30 MPa. The outer appearance of the optical device 1 produced under such conditions was favorable.

### Example 4

The substrate temperature during film formation was 85° C., the thickness of the second bonding film 15 was 700 nm, the temperature during pressurization was 35° C., and the applied pressure was 30 MPa. The outer appearance of the optical device 1 produced under such conditions was favorable.

### Comparative Example 3

The substrate temperature during film formation was 85° C., the thickness of the second bonding film 15 was 250 nm, the temperature during pressurization was 35° C., and the applied pressure was 30 MPa. In the optical device 1 produced under such conditions, streaky air bubbles remained in the polarizing layer 13 in the form of a film.

### Comparative Example 4

The substrate temperature during film formation was 85° C., the thickness of the second bonding film 15 was 750 nm, the temperature during pressurization was 35° C., and the applied pressure was 30 MPa. In the optical device 1 produced under such conditions, an outer peripheral portion of the polarizing layer 13 in the form of a film was shrunk and deformed, and bonding failure was caused.

As described above, from the experimental results of Examples 3 and 4 and Comparative Examples 3 and 4, it is found that when the thickness of the second bonding film 15 formed of a plasma-polymerized film is 300 nm or more and 700 nm or less, the irregularities of the polarizing layer 13 in the form of a film can be absorbed, and bonding failure caused by thermal shrinkage deformation can be avoided.

### Example 5

The substrate temperature during film formation was 75° C., the thickness of the second bonding film 15 was 500 nm, the temperature during pressurization was 20° C., and the applied pressure was 30 MPa. The outer appearance of the optical device 1 produced under such conditions was favorable.

### Example 6

The substrate temperature during film formation was 75° C., the thickness of the second bonding film 15 was 500 nm, the temperature during pressurization was 50° C., and the applied pressure was 30 MPa. The outer appearance of the optical device 1 produced under such conditions was favorable.

### Comparative Example 5

The substrate temperature during film formation was 75° C., the thickness of the second bonding film 15 was 500 nm, the temperature during pressurization was 55° C., and the applied pressure was 30 MPa. In the optical device 1 produced under such conditions, the adhesive constituting the first bonding film 14 protruded from the outer periphery, and the outer appearance was poor.

As described above, from the experimental results of Examples 5 and 6 and Comparative Example 5, it is found that when the temperature during pressurization is too high, the adhesive is plastically deformed due to heat, and protrudes from the outer periphery by the applied pressure. Incidentally, as the first bonding film 14 used in Examples 5 and 6 and Comparative Example 5, an acrylic adhesive was used.

### Example 7

The substrate temperature during film formation was 75° C., the thickness of the second bonding film 15 was 500 nm, the temperature during pressurization was 35° C., and the applied pressure was 30 MPa. The outer appearance of the optical device 1 produced under such conditions was favorable.

### Comparative Example 6

The substrate temperature during film formation was 75° C., the thickness of the second bonding film 15 was 500 nm, the temperature during pressurization was 35° C., and the applied pressure was 2.5 MPa. In the optical device 1 produced under such conditions, streaky air bubbles remained in the polarizing layer 13 in the form of a film.

As described above, from the experimental results of Example 7 and Comparative Example 6, it is found that in order to absorb the irregularities of the polarizing layer 13 in the form of a film, it is necessary to bring the polarizing layer 13 and the second substrate 12 into close contact with each other, and therefore, a pressure of 3 MPa or more is needed to be applied.

The conditions and results of Examples 1 to 7 and Comparative examples 1 to 6 are summarized in Table 1.

TABLE 1

| | | Film formation | | | | |
|---|---|---|---|---|---|---|
| | | Substrate | | Pressurization | | |
| | | temperature | Thickness | Temperature | Pressure | |
| | | (° C.) | (nm) | (° C.) | (MPa) | |
| | | Optimal range | | | | Results |
| | | 65 to 85 | 300 to 700 | 20 to 50 | 3 or more | Outer appearance |
| Conditions for | Example 1 | 65 | 500 | 35 | 30 | Favorable |
| substrate | Example 2 | 85 | 500 | 35 | 30 | Favorable |
| temperature during | Comparative | 60 | 500 | 35 | 30 | Fine air bubbles |
| film formation was | Example 1 | | | | | |
| changed | Comparative | 90 | 500 | 35 | 30 | Bonding failure |
| | Example 2 | | | | | in outer |
| | | | | | | periphery |
| Conditions for film | Example 3 | 85 | 300 | 35 | 30 | Favorable |
| thickness during | Example 4 | 85 | 700 | 35 | 30 | Favorable |
| film formation was | Comparative | 85 | 250 | 35 | 30 | Streaky air |
| changed | Example 3 | | | | | bubbles |
| | Comparative | 85 | 750 | 35 | 30 | Bonding failure |
| | Example 4 | | | | | in outer |
| | | | | | | periphery |
| Conditions for | Example 5 | 75 | 500 | 20 | 30 | Favorable |
| temperature during | Example 6 | 75 | 500 | 50 | 30 | Favorable |
| pressurization was | Comparative | 75 | 500 | 55 | 30 | Protrusion of |
| changed | Example 5 | | | | | adhesive |
| Applied pressure | Example 7 | 75 | 500 | 35 | 30 | Favorable |
| was changed | Comparative | 75 | 500 | 35 | 2.5 | Streaky air |
| | Example 6 | | | | | bubbles |

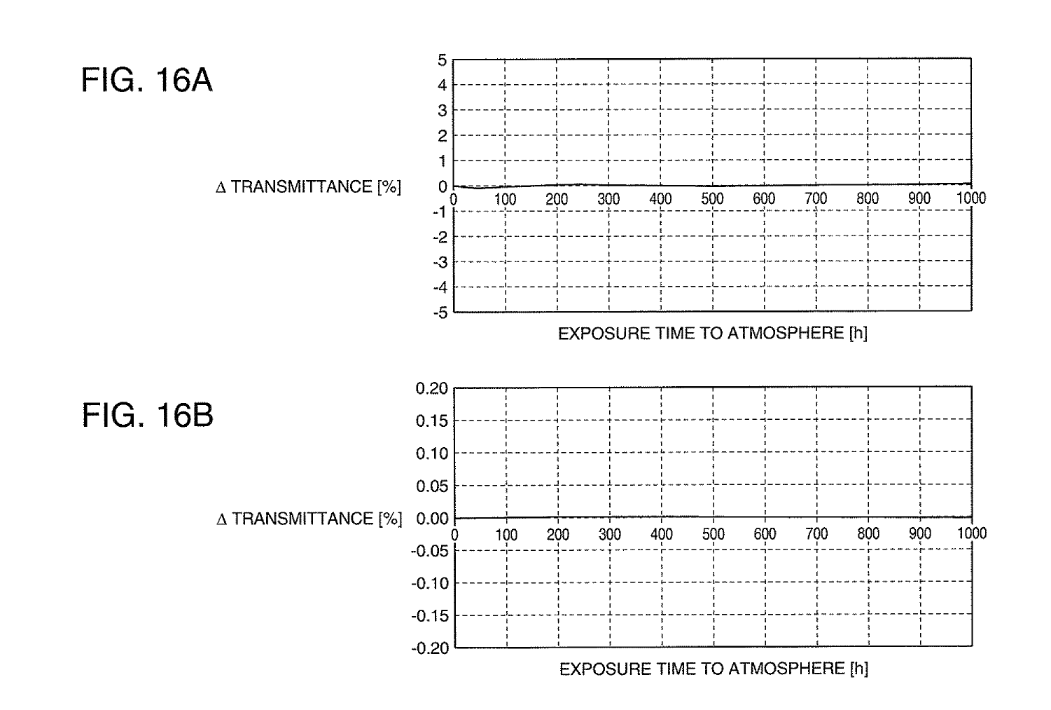

Next, Experimental Examples for the evaluation of reliability will be described with reference to FIGS. 16A to 19B.

In this experiment, the variation in transmittance was compared between the optical device 1 of Example produced according to the above embodiment and an optical device of the related art in which a first substrate, a second substrate, and a polarizer in the form of a film composed of PVA are bonded and fixed to one another with a UV curable bonding agent.

The variation in transmittance was measured in accordance with the xenon arc lamp type light resistance test specified in JIS B 7754, and the variation in transmittance versus the exposure time to the atmosphere was determined. In this experiment, a black panel temperature was set to 63° C.

FIGS. 16A and 16B show the variation in transmittance versus the exposure time to the atmosphere of the optical device of the present Example for green (a green wavelength region), and FIG. 16A is a graph showing the variation in transmittance thereof for the parallel component and FIG. 16B is a graph showing the variation in transmittance thereof for the perpendicular component.

As shown in FIG. 16A, the transmittance thereof for the parallel component varies by only −0.05% even if the exposure time to the atmosphere progresses and is found to vary little.

As shown in FIG. 16B, the transmittance thereof for the perpendicular component does not vary even if the exposure time to the atmosphere progresses (0.00%).

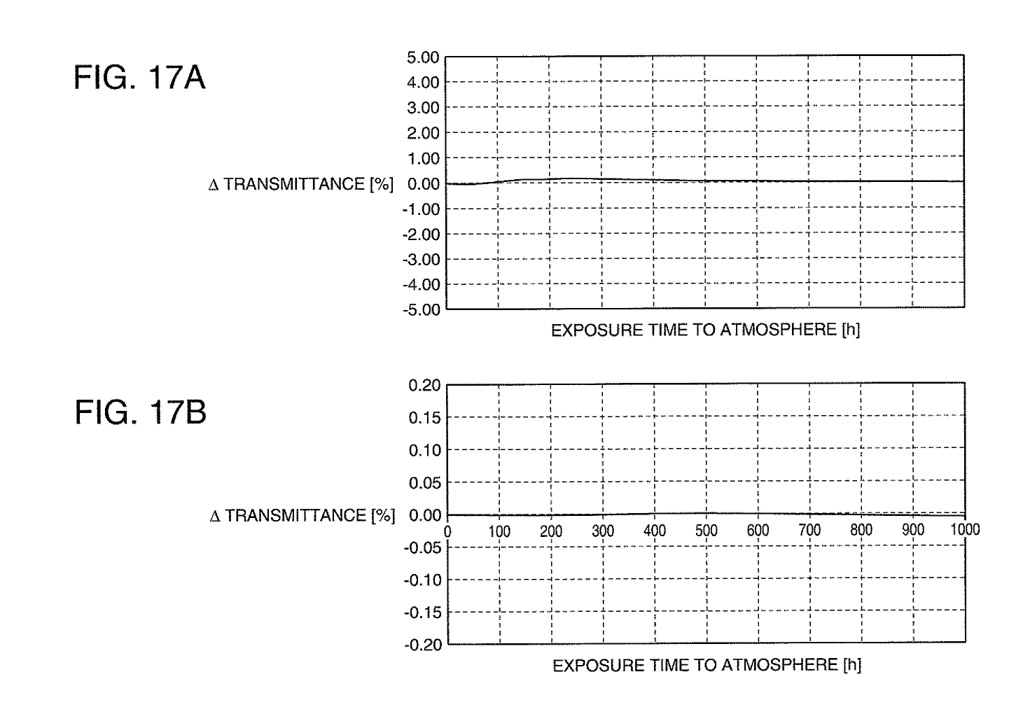

FIGS. 17A and 17B show the variation in transmittance versus the exposure time to the atmosphere of the optical device of the present Example for blue (a blue wavelength region from 430 nm to 500 nm), and FIG. 17A is a graph showing the variation in transmittance thereof for the parallel component and FIG. 17B is a graph showing the variation in transmittance thereof for the perpendicular component.

As shown in FIG. 17A, the transmittance thereof for the parallel component varies by only 0.06% even if the exposure time to the atmosphere progresses and is found to vary little.

As shown in FIG. 17B, the transmittance thereof for the perpendicular component varies by only −0.01% even if the exposure time to the atmosphere progresses and is found to vary little.

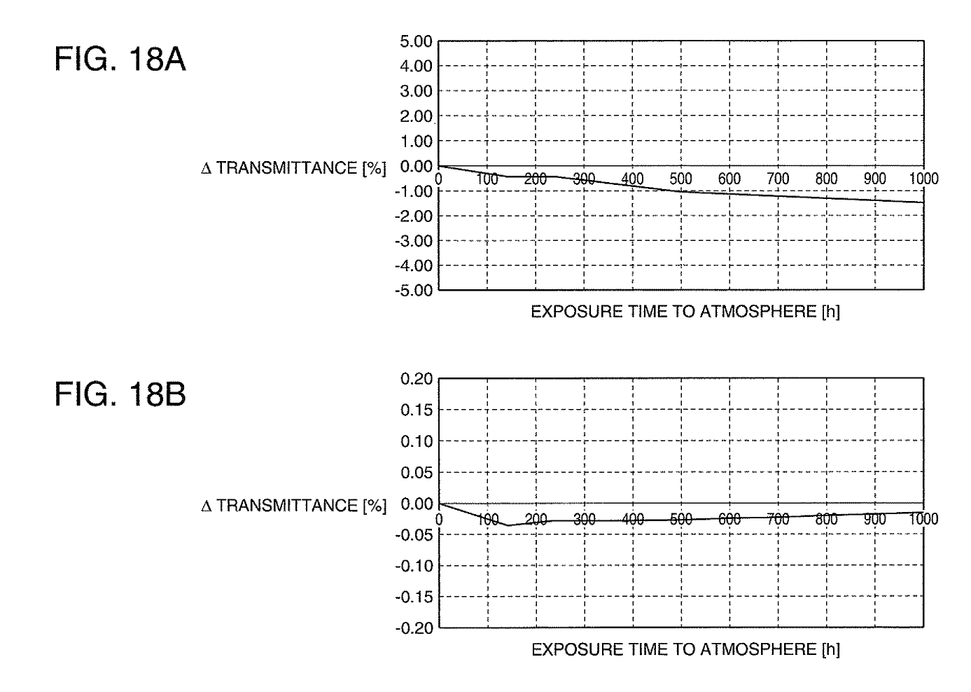

FIGS. 18A and 18B show the variation in transmittance versus the exposure time to the atmosphere of the optical device of Comparative Example for green (a green wavelength region), and FIG. 18A is a graph showing the variation in transmittance thereof for the parallel component and FIG. 18B is a graph showing the variation in transmittance thereof for the perpendicular component.

As shown in FIG. 18A, the transmittance thereof for the parallel component varies by as much as −1.49% as the exposure time to the atmosphere progresses.

As shown in FIG. 18B, the transmittance thereof for the perpendicular component varies by −0.02% as the exposure time to the atmosphere progresses.

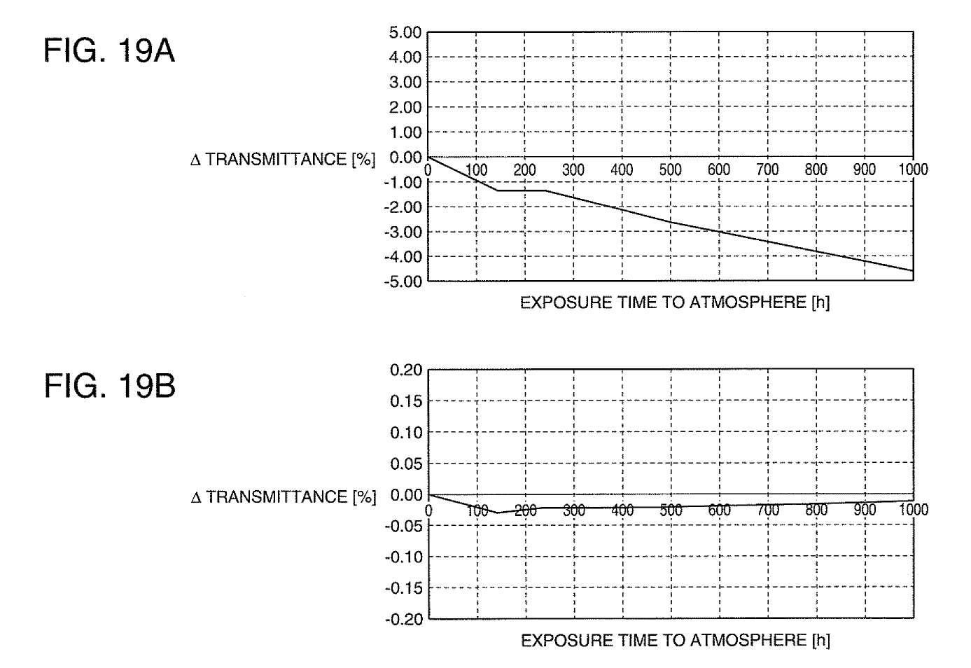

FIGS. 19A and 19B show the variation in transmittance versus the exposure time to the atmosphere of the optical device of Comparative Example for blue (a blue wavelength region from 430 nm to 500 nm), and FIG. 19A is a graph showing the variation in transmittance thereof for the parallel component and FIG. 19B is a graph showing the variation in transmittance thereof for the perpendicular component.

As shown in FIG. 19A, the transmittance thereof for the parallel component varies by as much as −4.57% as the exposure time to the atmosphere progresses.

As shown in FIG. 19B, the transmittance thereof for the perpendicular component varies by −0.01% as the exposure time to the atmosphere progresses.

As described above, when comparison is made between the present Example and Comparative Example for each of the green region and the blue region, it is found that the present Example shows a small variation in transmittance as compared with Comparative Example, and has excellent light resistance.

Note that the invention is not limited to the above-described embodiments and includes modifications described below within a scope capable of achieving the objects of the invention.

For example, in the above-described respective embodiments, as the resin layer constituting the optical device 1, a polarizing layer and a retardation element are exemplified. However, in the invention, other than the polarizing layer and the retardation element, an infrared absorbing film, a viewing angle widening film for liquid crystal display, a film for an ND (neutral density) filter, or an optical film with a multi-layered resin film can be used as the resin layer.

Further, in the above-described respective embodiments, the sealing part 16 is formed in a circular shape in the recess 1C formed continuously on the four sides of the first substrate 11 and the second substrate 12. However, in the invention, a configuration in which the sealing part 16 is not formed in some regions of all or some sides may be adopted, and further a configuration in which the sealing part 16 is formed in one side or two sides adjacent to each other, and on the other remaining sides, end portions of the first substrate 11 and the second substrate 12 are held by a clip or the like (not shown) may be adopted.

Further, the region where the sealing part 16 is provided is not limited to the recess 1C, and the outer shapes of the resin layer, the first bonding film 14, and the second bonding film 15 are not limited as long as the sealing part 16 is provided on the lateral surface of the resin layer. For example, the case where the outer shape of the resin layer is smaller than the outer shapes of the first bonding film 14 and the second bonding film 15, or the case where the outer shape of the resin layer is larger than the outer shapes of the first bonding film 14 and the second bonding film 15, that is, other than the shape of the recess formed of three surfaces as described in the above embodiments, i.e., the surfaces of the first substrate 11 and the second substrate 12 facing each other and the lateral surfaces of the resin layer the first bonding film 14, and the second bonding film 15, the recess may have a shape such that the resin layer portion of the recess is further recessed, or a shape such that the resin layer portion protrudes from the recess.

Further, the configuration of the invention can also be applied to an optical pickup apparatus. That is, in an optical pickup apparatus, a ½ wavelength plate for rotating linearly polarized light output from a laser light source and a ¼ wavelength plate for rotating linearly polarized light to form circularly polarized light are used. These wavelength plates are made of a resin, and the configuration of the invention can be applied to the wavelength plates made of a resin. In this case, the first substrate and the second substrate are typically made of glass. In addition, it is possible to apply another optical member such as a prism to the first substrate or the second substrate. In this case, the resin layer is a ½ wavelength plate or a ¼ wavelength plate.

Further, in the above-described respective embodiments, the second bonding film 15 is formed by a plasma polymerization method. However, in the invention, the second bonding film 15 may be formed by any of various gas phase film formation methods such as a CVD method and a PVD method, various liquid phase film formation methods, etc. other than the plasma polymerization method.

Further, in the invention, the optical device can be used in electronic apparatuses such as digital cameras other than projection-type imaging apparatuses and optical pickup apparatuses.

The invention can be utilized in a projection-type imaging apparatus such as a liquid crystal projector and other electronic apparatuses.

The entire disclosure of Japanese Patent Application No. 2011-174925 filed Aug. 11, 2011 is expressly incorporated herein.

What is claimed is:

1. An optical device comprising:
a light transmissive first substrate;
a light transmissive second substrate;
a resin layer;
a first bonding film which bonds the first substrate to one principal surface of the resin layer; and
a second bonding film which bonds the second substrate to the other principal surface of the resin layer, wherein
the outer shapes of the first substrate and the second substrate are larger than that of the resin layer;
a sealing part for sealing with a sealant is provided on a lateral surface of the resin layer such that the sealing part is interposed between the first substrate and the second substrate;
the first bonding film is an adhesive, and
the second bonding film contains a Si skeleton which has an atomic structure containing a siloxane (Si—O) bond and a leaving group which binds to the Si skeleton.

2. The optical device according to claim 1, wherein the sealant is a cure-shrinkable bonding agent.

3. The optical device according to claim 1, wherein the outer shape of one of the first substrate and the second substrate is larger than that of the other one.

4. The optical device according to claim 3, wherein the sealant is attached to a lateral surface of the other one of the first substrate and the second substrate.

5. The optical device according to claim 1, wherein the resin layer is a polarizing layer or a retardation element.

6. A method for producing an optical device, which is a method for producing the optical device according to claim 1, comprising:
bonding the first substrate to one principal surface of the resin layer with an adhesive;
forming a first bonding layer, which contains a Si skeleton that has an atomic structure containing a siloxane (Si—O) bond and a leaving group that binds to the Si skeleton, on at least one principal surface of the other principal surface of the resin layer and a principal surface of the second substrate;
activating the first bonding layer formed in the forming of the first bonding layer;
bonding the resin layer to the second substrate so as to integrate the members; and
supplying a sealant to a region on a lateral surface of the resin layer, the region being interposed between the first substrate and the second substrate.

7. A method for producing an optical device, which is a method for producing the optical device according to claim 2, comprising:
bonding the first substrate to one principal surface of the resin layer with an adhesive;
forming a first bonding layer, which contains a Si skeleton that has an atomic structure containing a siloxane (Si—O) bond and a leaving group that binds to the Si skeleton, on at least one principal surface of the other principal surface of the resin layer and a principal surface of the second substrate;
activating the first bonding layer formed in the forming of the first bonding layer;
bonding the resin layer to the second substrate so as to integrate the members; and
supplying a sealant to a region on a lateral surface of the resin layer, the region being interposed between the first substrate and the second substrate.

8. A method for producing an optical device, which is a method for producing the optical device according to claim 3, comprising:
bonding the first substrate to one principal surface of the resin layer with an adhesive;
forming a first bonding layer, which contains a Si skeleton that has an atomic structure containing a siloxane (Si—O) bond and a leaving group that binds to the Si skeleton, on at least one principal surface of the other principal surface of the resin layer and a principal surface of the second substrate;
activating the first bonding layer formed in the forming of the first bonding layer;
bonding the resin layer to the second substrate so as to integrate the members; and
supplying a sealant to a region on a lateral surface of the resin layer, the region being interposed between the first substrate and the second substrate.

9. A method for producing an optical device, which is a method for producing the optical device according to claim 4, comprising:
bonding the first substrate to one principal surface of the resin layer with an adhesive;
forming a first bonding layer, which contains a Si skeleton that has an atomic structure containing a siloxane (Si—O) bond and a leaving group that binds to the Si skeleton, on at least one principal surface of the other principal surface of the resin layer and a principal surface of the second substrate;
activating the first bonding layer formed in the forming of the first bonding layer;
bonding the resin layer to the second substrate so as to integrate the members; and
supplying a sealant to a region on a lateral surface of the resin layer, the region being interposed between the first substrate and the second substrate.

10. A method for producing an optical device, which is a method for producing the optical device according to claim 5, comprising:
bonding the first substrate to one principal surface of the resin layer with an adhesive;
forming a first bonding layer, which contains a Si, skeleton that has an atomic structure containing a siloxane (Si—O) bond and a leaving group that binds to the Si skeleton, on at least one principal surface of the other principal surface of the resin layer and a principal surface of the second substrate;
activating the first bonding layer formed in the forming of the first bonding layer;
bonding the resin layer to the second substrate so as to integrate the members; and
supplying a sealant to a region on a lateral surface of the resin layer, the region being interposed between the first substrate and the second substrate.

11. The method for producing an optical device according to claim 6, wherein in the supplying of the sealant, the sealant is supplied to the region through a notch formed in one of an end portion of the first substrate and an end portion of the second substrate.

12. The method for producing an optical device according to claim 7, wherein in the supplying of the sealant, the sealant is supplied to the region through a notch formed in one of an end portion of the first substrate and an end portion of the second substrate.

13. The method for producing an optical device according to claim 8, wherein in the supplying of the sealant, the sealant is supplied to the region through a notch formed in one of an end portion of the first substrate and an end portion of the second substrate.

14. The method for producing an optical device according to claim 9, wherein in the supplying of the sealant, the sealant is supplied to the region through a notch formed in one of an end portion of the first substrate and an end portion of the second substrate.

15. The method for producing an optical device according to claim 10, wherein in the supplying of the sealant, the sealant is supplied to the region through a notch formed in one of an end portion of the first substrate and an end portion of the second substrate.

16. A projection-type imaging apparatus comprising:
a light source;
a light modulator which modulates light from the light source according to image information;
a projection optical device which projects the light modulated by the light modulator; and
a polarizing plate, wherein
the polarizing plate is disposed on at least one of a light incident side and a light exit side of the light modulator, and
the polarizing plate is the optical device according to claim 1.

17. A projection-type imaging apparatus comprising:
a light source;
a light modulator which modulates light from the light source according to image information;
a projection optical device which projects the light modulated by the light modulator; and
a polarizing plate, wherein
the polarizing plate is disposed on at least one of a light incident side and a light exit side of the light modulator, and
the polarizing plate is the optical device according to claim 2.

18. A projection-type imaging apparatus comprising:
a light source;
a light modulator which modulates light from the light source according to image information;
a projection optical device which projects the light modulated by the light modulator; and
a polarizing plate, wherein
the polarizing plate is disposed on at least one of a light incident side and a light exit side of the light modulator, and
the polarizing plate is the optical device according to claim 3.

19. A projection-type imaging apparatus comprising:
a light source;
a light modulator which modulates light from the light source according to image information;
a projection optical device which projects the light modulated by the light modulator; and
a polarizing plate, wherein
the polarizing plate is disposed on at least one of a light incident side and a light exit side of the light modulator, and
the polarizing plate is the optical device according to claim 4.

20. A projection-type imaging apparatus comprising:
a light source;
a light modulator which modulates light from the light source according to image information;
a projection optical device which projects the light modulated by the light modulator; and
a polarizing plate, wherein
the polarizing plate is disposed on at least one of a light incident side and a light exit side of the light modulator, and
the polarizing plate is the optical device according to claim 5.
